(19) United States
(12) Patent Application Publication
(10) Pub. No.: US 2024/0249318 A1
(43) Pub. Date: Jul. 25, 2024

(54) DETERMINING USER INTENT FROM CHATBOT INTERACTIONS

(71) Applicants: Evan Spiegel, Los Angeles, CA (US); Robert Cornelius Murphy, Venice, CA (US); Celia Nicole Mourkogiannis, Los Angeles, CA (US); Edward Mata, Orinda, CA (US); Eitan Pilipski, Los Angeles, CA (US); Jacob Andreou, Santa Monica, CA (US); Jackie Assa, Herzliya (IL); Joshua Siegel, Venice, CA (US); Nima Khajehnouri, Santa Monica, CA (US); Steven Hwang, Rolling Hills Estates, CA (US); Daniel Moreno, New York, NY (US); Jacob Catalano, Santa Monica, CA (US); Charles Melbye, Sherman Oaks, CA (US)

(72) Inventors: Evan Spiegel, Los Angeles, CA (US); Robert Cornelius Murphy, Venice, CA (US); Celia Nicole Mourkogiannis, Los Angeles, CA (US); Edward Mata, Orinda, CA (US); Eitan Pilipski, Los Angeles, CA (US); Jacob Andreou, Santa Monica, CA (US); Jackie Assa, Herzliya (IL); Joshua Siegel, Venice, CA (US); Nima Khajehnouri, Santa Monica, CA (US); Steven Hwang, Rolling Hills Estates, CA (US); Daniel Moreno, New York, NY (US); Jacob Catalano, Santa Monica, CA (US); Charles Melbye, Sherman Oaks, CA (US)

(21) Appl. No.: 18/420,546

(22) Filed: Jan. 23, 2024

Related U.S. Application Data
(60) Provisional application No. 63/440,785, filed on Jan. 24, 2023.

(51) Int. Cl. G06Q 30/0251; G06Q 30/0241; H04L 51/02

(52) U.S. Cl. CPC G06Q 30/0257; G06Q 30/0277; H04L 51/02

(57) ABSTRACT

A system and method for determining user intent and providing targeted advertising using chatbot interactions is disclosed. The system receives user prompts during chat sessions with a chatbot and generates responses using a large language model. User intent is extracted by analyzing the chat conversations using natural language processing and machine learning techniques. The extracted user intent, comprising weighted keywords and concepts, is used to create a user intent profile. Targeted advertising content is generated based on the user intent profile and provided to the user during subsequent platform interactions. The large language model is continuously retrained using user engagement data to improve intent modeling accuracy. User privacy is maintained by limiting context extraction to chatbot conversations. The system enables personalized and relevant advertising by inferring user intent through conversational interactions.

### PRIORITY CLAIM

This application claims the benefit of U.S. Provisional Application No. 63/440,785, filed on Jan. 24, 2023, which is hereby incorporated by reference in its entirety.

### TECHNICAL FIELD

The present disclosure relates generally to interactive platforms and more particularly to providing user interfaces to users of an interactive platform.

### BACKGROUND

Users enjoy accessing interactive platforms to share content with other users of the interactive platform. In addition, users often access useful information using the various features of the interactive platforms.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3A is an illustration of an interactive session by a user with a chatbot system, according to some examples.

FIG. 3B is a block diagram of the chatbot system, according to some examples.

FIG. 3C is a process flow diagram of a chat and advertising process of the chatbot system, according to some examples.

FIG. 3D is a process flow diagram of an advertising creation process, according to some examples.

FIG. 4A is a tech block diagram, according to some examples.

FIG. 4B is an activity diagram of a method of a chatbot system, according to some examples.

FIG. 5A and FIG. 5B are illustrations of a user interface, according to some examples.

FIG. 6 illustrates a machine-learning pipeline, according to some examples.

FIG. 7 illustrates training and use of a machine-learning program, according to some examples.

FIG. 8 is a diagrammatic representation of a data structure as maintained in a database, according to some examples.

FIG. 9 is a diagrammatic representation of a message, according to some examples.

FIG. 10 is a flowchart for an access-limiting process, according to some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

### DETAILED DESCRIPTION

Interactive platforms (e.g., social platforms, social media platforms AR platforms, applications, messaging platforms, AR applications, operating systems, gaming systems or applications, systems with which a user interacts, and the like) may provide a way for users to interact with other users with similar interests. As interactive platforms may not charge for access to such platforms, an owner of an interactive platform may decide to serve advertising content to users based on interests of the users. Both users and owners of interactive platforms desire to see advertisements (“ads”) that are more relevant to a user's intent, which can make the ads more engaging and less disruptive to the user's experience. In addition, advertisers desire a way to easily provide engaging advertising content.

Various examples provide improved user intent detection during conversations with chatbots of an interactive platform. A chatbot, in some examples, is a software application that is designed to simulate human conversation through voice commands or text chats. A chatbot may employ Natural Language Processing (NLP) and Machine Learning (ML)/Artificial Intelligence (AI) methodologies to understand and interpret a user's input and generate a response.

In some examples, improved user intent detection allows advertisers to bid and target their ads to specific user segments based on a user's intent and interests, which can increase the chances that the user will engage with the ad. Advertisers can have faster ramp up time by providing targeted keywords. In addition, advertisers can benefit from automated creative generation which is based on matching user intent to advertisers' targeted user intent.

In some examples, a chatbot system provides user intent detection that improves targeting and optimization capabilities over time by analyzing data on user intent and conversions. This enhances the user experience and improves the relevance and performance of ads. Additionally, the interactive platform uses the extracted user intent to enhance the user experience across other portions of the interactive platforming site, making them more personalized and relevant to the user community. In some examples, an interactive platform enhances display advertising by targeting users based on their genuine intent ascertained, in whole or in part, through interaction with a chatbot. By extracting high intent and timely relevant keywords and concepts of conversation with the chatbot, the interactive platform may improve a user intent profile.

In some examples, advertisers target and bid for specific keywords or expanded concepts, which enables them to reach a highly targeted group of users.

Some platforms currently rely on traditional methods of ad targeting, such as demographic information and browsing and engagement history, which have limitations in terms of targeting users based on their direct and recent intent. With recent changes in privacy regulations, it has become increasingly difficult to obtain user intent information through third-party channels as well. Examples of this disclosure address these limitations by utilizing Large Language Models (LLMs) or AI systems and context extraction from conversations with a chatbot to target users with relevant ads. By using the context of conversations with the chatbot, an interactive platform can provide a more accurate and up-to-date representation of user intent and enable more effective ad targeting without endangering the privacy of users.

In some examples, users may interact with a chatbot in several different ways. Users can chat with the chatbot directly, in this scenario the whole conversation is utilized towards building the user intent. This also allows the chatbot system to extract accurate information about a user intent, as the user will be expressing their interests and needs directly to the chatbot. In some examples, users can be in a 1:1 chat with a friend and add the chatbot into the conversation using a tag, for example @mention. In this case, the prompt after the @mention can be utilized towards the user intent or the whole conversation may be used after the chatbot is added into the user intent extraction. In this manner, the platform can extract information about the user's intent from the context of the conversation and not only the prompt. In a group chat, the user can add the chatbot to the conversation. And the data extraction scenarios could be similar to 1:1 chats.

In some examples, an intent extraction pipeline maps conversations to an intent vector of important and intentful keywords and expanded concepts. This intent vector is a dynamic representation of a user's intent, which is updated in close to real-time as the user engages in conversations with the chatbot. So, the user's intent will be defined by a combination of demographics, engagement embeddings in the system and the keywords and concepts vector.

In some examples, the intent vector is a rich representation of a user's intent and the similarity of two vectors shows how closely two users' intents match. This can be used for “look-a-like” targeting and audience expansion, allowing the interactive platform to quickly identify and target users who are similar to those who have already engaged with ads.

In some examples, textual components of ads are used to finetune the responses of an LLM, thus conditioning the responses of the large language model. This improves the suggestions by the chatbot system and improves user engagement.

In some examples, advertisers can use the concept vector to choose the target audience for their ads. They can bid on specific keywords and expanded concepts which allows them to target users who are likely to be interested in their product or service. Newer and smaller advertisers can also find relevant audiences by specifying a few key keywords, and the chatbot system will match that to a broader group of users.

In some examples, the chatbot system has detailed control over the context that is extracted from the conversations, so the list of possible keywords and concepts can be curated and adjusted as the platform evolves. The chatbot system can also learn new concepts on a daily basis and the list of acceptable expanded concepts can be moderated and curated to ensure they are relevant and appropriate for the platform. Overall, this platform uses the representation of user intent to provide a more personalized and engaging experience for users and more targeting options for advertisers. The intent vector can be used for many purposes, such as audience expansion, look-a-like targeting, and fast cold-start ramp-up.

In some examples, the chatbot system can be used in conjunction with many organic experiences such as content, search, augmented reality and engagement with mapping applications. This allows the interactive platform as a whole to be more efficient in targeting the right audience and improve the performance of the ads and organic experiences.

In some examples, the chatbot system preserves user privacy, as the chatbot system only uses a conversation when the chatbot is opted into the conversation and expanded concepts are from a curated list of potential bidding concepts.

In some examples, a chatbot system receives a prompt from a user during a first interactive session. The chatbot system generates a response using the prompt and a large language model. The chatbot system communicates the response to the user during the first interactive session. The chatbot system determines a user intent based on the user prompt and response. The chatbot system determines advertising content based on the user intent. The chatbot system communicates the advertising content to the user during a second interactive session.

In some examples, the first interactive session is a chat session between the user and the chatbot system, while the second interactive session is not.

In some examples, the chatbot system generates a raw response based on the prompt, generates an adjusted prompt based on filtering the raw response, and generates the final response using the adjusted prompt.

In some examples, the chatbot system generates potential responses, selects one response from the potentials, and determines user intent based on the potential responses.

In some examples, the chatbot system determines user intent based on a user profile, which may include social network data.

In some examples, the chatbot system is a component of an interactive platform, a social platform, social media platform, a social network, an AR platform, an application, a messaging application, an AR application, an operating system, a gaming system or application, or any other system, media, or application with which a user can interact with.

### Networked Computing Environment

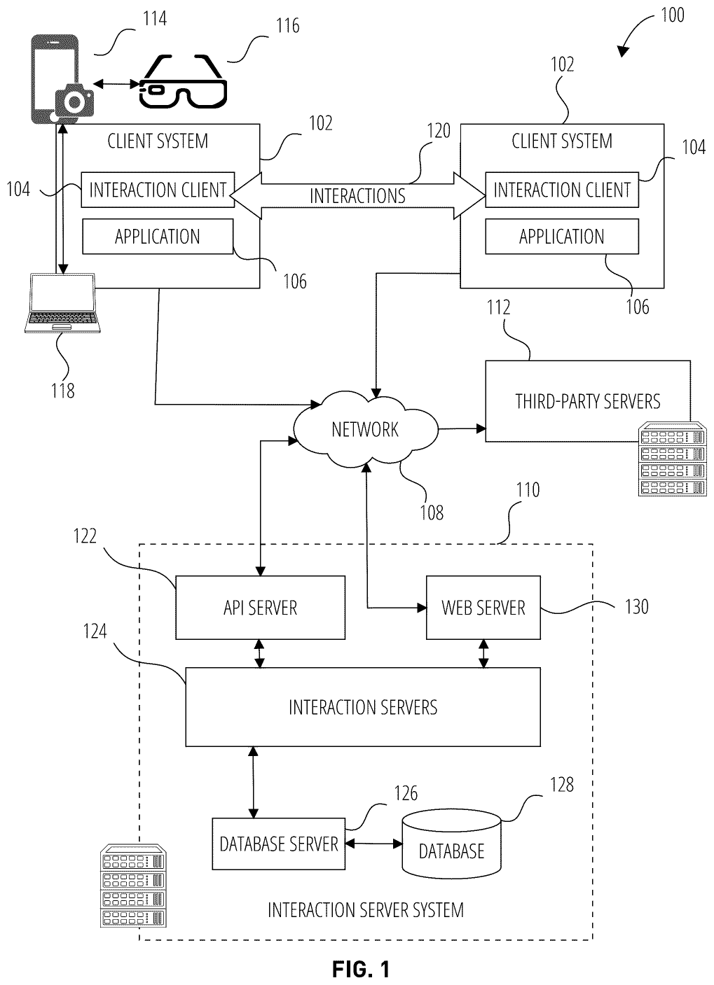

FIG. 1 is a block diagram showing an example interaction system 100 of an interactive platform for facilitating interactions (e.g., exchanging text messages, conducting text audio and video calls, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other client systems 102), an interaction server system 110 and third-party servers 112). An interaction client 104 can also communicate with locally hosted applications 106 using Applications Programming Interfaces (APIs).

Each client system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a client system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, interactive platform information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the client systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a client system 102; the retrieval of messages and content; the addition and deletion of entities (e.g., friends) to an entity graph (e.g., a social graph); the location of friends within a social graph; and opening an application event (e.g., relating to the interaction client 104).

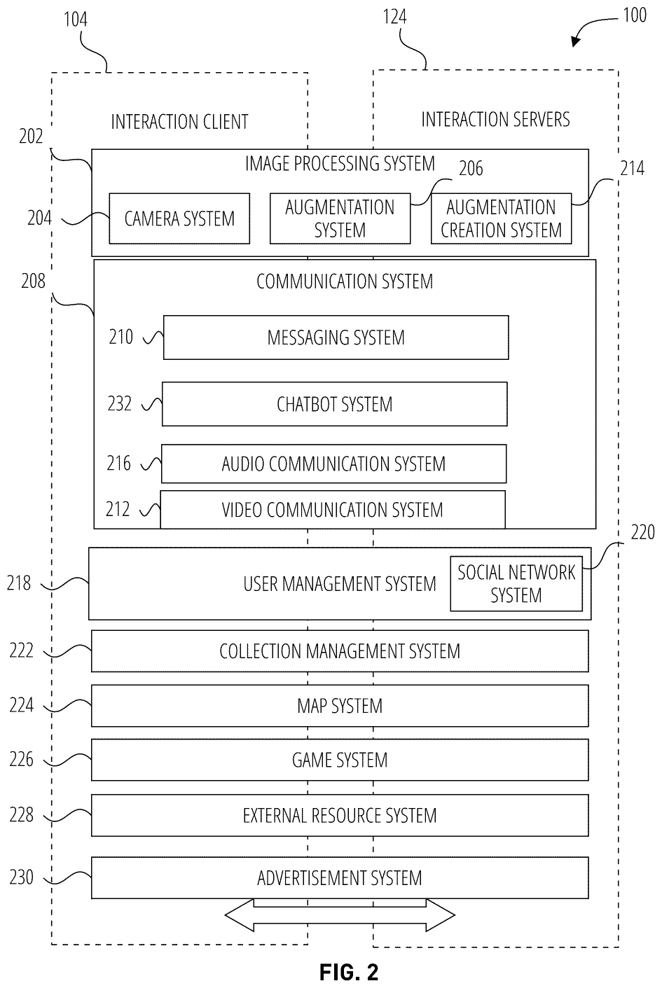

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the client system 102 (e.g., a “native app”), or a small-scale version of the application (e.g., an “applet”) that is hosted on the client system 102 or remote of the client system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the client system 102 can be launched independently of and separately from the interaction client 104, such as by selecting an icon corresponding to the application 106 on a home screen of the client system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the client system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the client system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., augment or otherwise modify or edit) media content associated with a message.

A camera system 204 includes control software (e.g., in a camera application) that interacts with and controls hardware camera hardware (e.g., directly or via operating system controls) of the client system 102 to modify and augment real-time images captured and displayed via the interaction client 104.

The augmentation system 206 provides functions related to the generation and publishing of augmentations (e.g., media overlays) for images captured in real-time by cameras of the client system 102 or retrieved from memory of the client system 102. For example, the augmentation system 206 operatively selects, presents, and displays media overlays (e.g., an image filter or an image lens) to the interaction client 104 for the augmentation of real-time images received via the camera system 204 or stored images retrieved from memory of a client system 102. These augmentations are selected by the augmentation system 206 and presented to a user of an interaction client 104, based on a number of inputs and data such as, but not limited to, geolocation of the client system 102, interactive platform information of the user of the client system 102, and the like.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at client system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the client system 102 or a video stream produced by the client system 102. In some examples, the media overlay may be a location overlay (e.g., Venice beach), a name of a live event, or a name of a merchant overlay (e.g., Beach Coffee House). In further examples, the image processing system 202 uses the geolocation of the client system 102 to identify a media overlay that includes the name of a merchant at the geolocation of the client system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, a chatbot system 232, an audio communication system 216, and a video communication system 212. The messaging system 210 is responsible for enforcing the temporary or time-limited access to content by the interaction clients 104. The messaging system 210 incorporates multiple timers within an ephemeral timer system (not shown) that, based on duration and display parameters associated with a message or collection of messages (e.g., a story), selectively enable access (e.g., for presentation and display) to messages and associated content via the interaction client 104. Further details regarding the operation of the ephemeral timer system are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104. The chatbot system 232 is responsible for generating responses to prompts received from a user and communicating a response to the prompt.

A user management system 218 is operationally responsible for the management of user data and profiles, and includes an interactive platform 220 that maintains interactive platform information regarding relationships between users of the interaction system 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media content and messages by the interaction client 104. For example, the map system 224 enables the display of user icons or avatars (e.g., stored in profile data 802) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a client system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

### Chatbot System

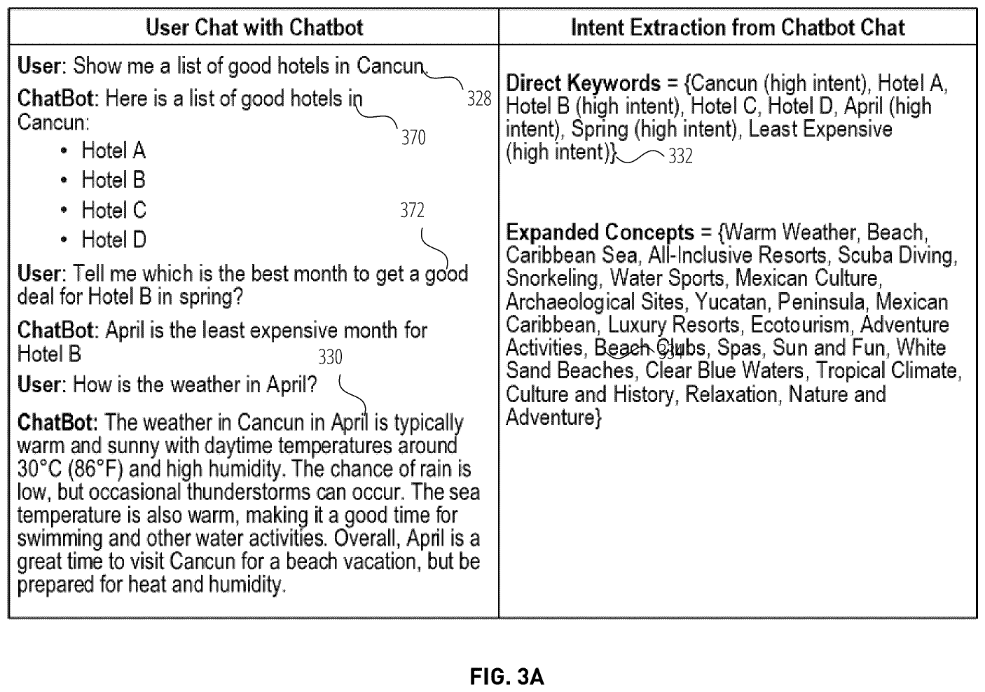

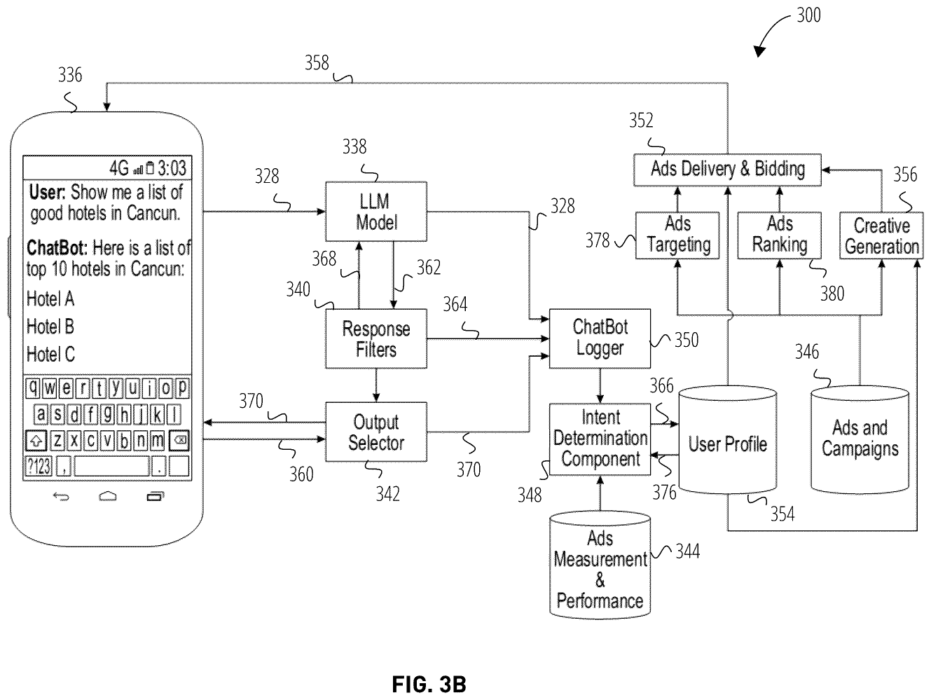

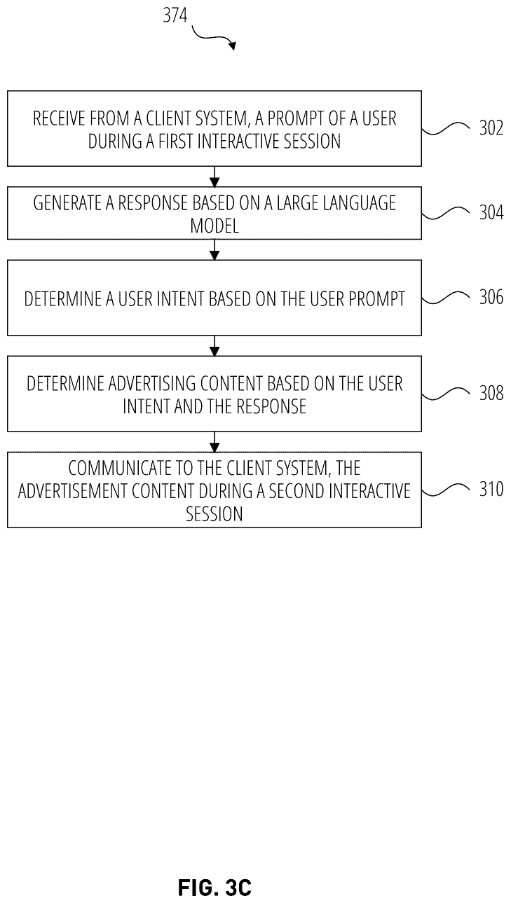

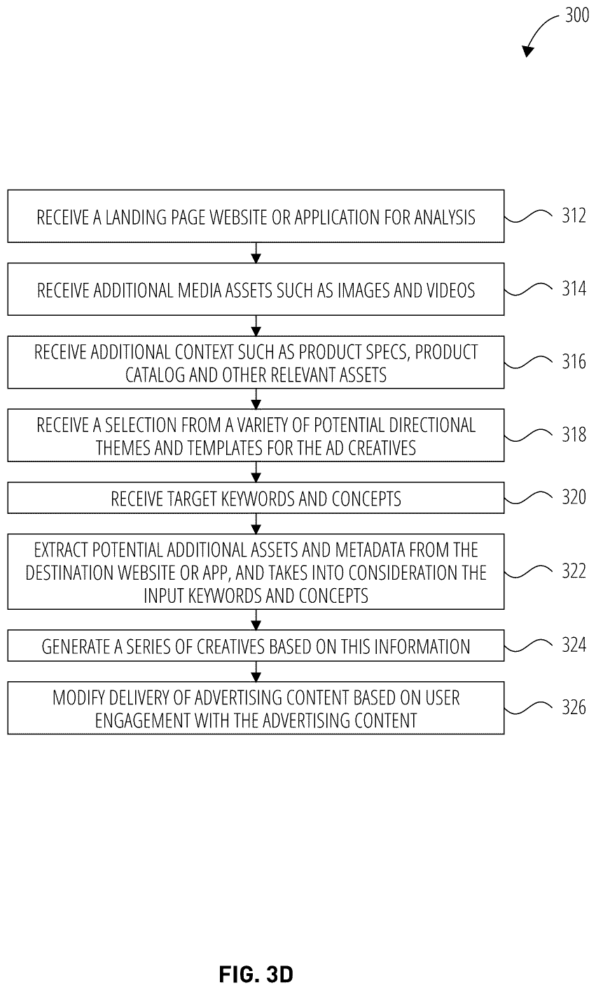

FIG. 3A is an illustration of an interactive session by a user with a chatbot system, FIG. 3B is an illustration of a block diagram of the chatbot system, and FIG. 3C is an illustration of a process flow diagram of a chat and advertising process of the chatbot system, according to some examples. A chatbot system 300 uses the chat and advertising process to conduct a chat session with a user during a (first) interactive session, and provide advertising content to the user in a later (second) interactive session.

The chatbot system 300, in some examples, is a software application that is designed to simulate human conversation through voice commands or text chats. It may employ natural language processing (NLP) and machine learning (ML)/artificial intelligence techniques to understand and interpret the user's input and generate a response.

In some examples, the chatbot's architecture comprises natural language understanding (NLU) components and dialogue management components. The NLU components are responsible for understanding a user's intent and extracting relevant information from the user's input. This is achieved by analyzing the user's input and mapping it to an intent. The NLU components can use various techniques such as rule-based systems, statistical models, and neural networks to understand the user's input. The dialogue management components, on the other hand, generates a response to the user's input. The use the intent and any extracted information from the NLU components to determine an appropriate response. This can be done using rule-based systems, decision trees, or machine learning models, and the like.

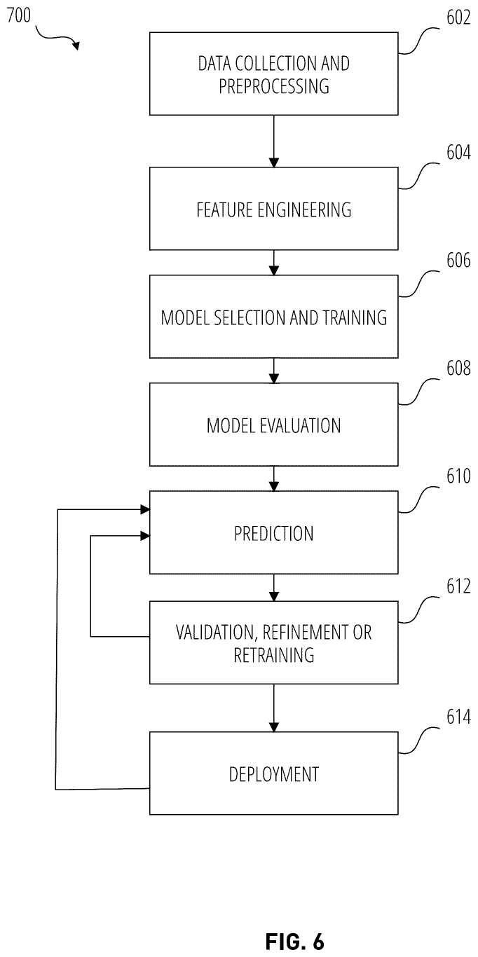

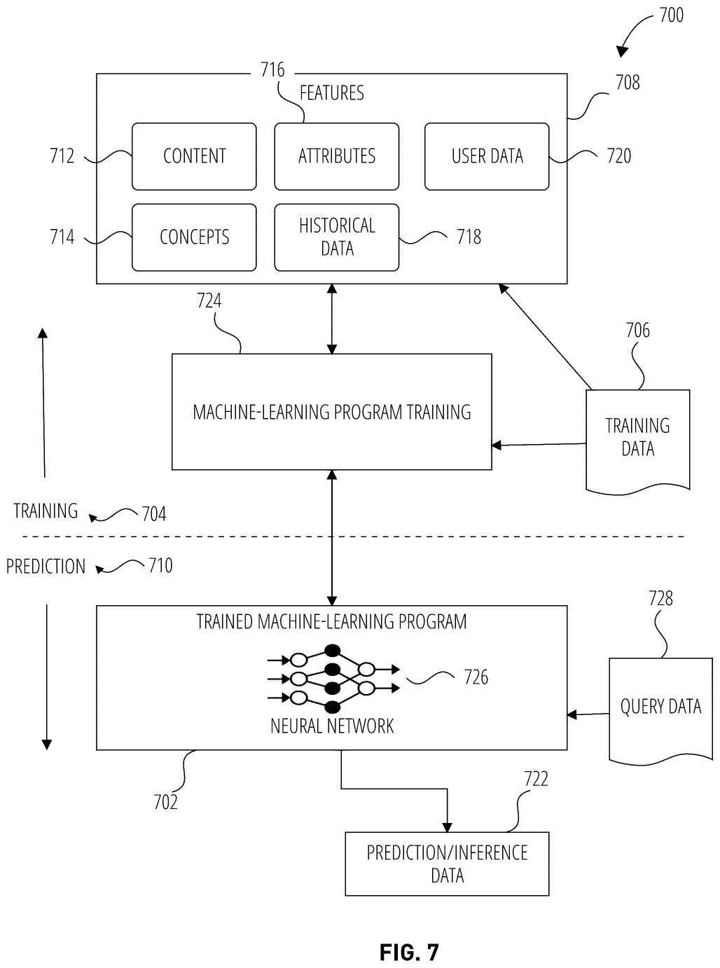

In some examples, a chatbot system 300 may use a generative AI model, such as a large language model (LLM) 338 or the like, to improve its natural language understanding (NLU) and dialogue management capabilities. The LLM 338 is more fully described in referenced to FIG. 6 and FIG. 7.

In some examples, the chatbot system 300 may use the LLM 338 to analyze the user's input and extract relevant information, such as the user's intent and entities. The LLM 338 can also be used to identify and extract important information from unstructured text, such as a user's question or request. This can be done using techniques such as named entity recognition, part-of-speech tagging, sentiment analysis, and the like.

When the NLU components have extracted the relevant information from the user's input, the dialogue management module can use the LLM 338 to generate an appropriate response. The LLM 338 can be used to generate responses in a human-like manner by using techniques such as text generation, machine learning models, and the like.

In some examples, the knowledge base of the chatbot system 300 comprises a set of information that the chatbot can use to understand and respond to a user's input. This includes a predefined set of intents, entities, and responses, as well as external sources of information such as databases or Application Programming Interfaces (APIs) and the like. In some examples, intent information of a friend, or friends, of the user may be used to understand, inform, and/or respond to a user's intent.

In some examples, the chatbot system 300 may be integrated into various platforms such as websites, messaging apps, and mobile apps, allowing users to interact with it through text or voice commands.

In operation 302 of chatbot method 374, the chatbot system 300 receives, from a client system 336, a prompt 328 of a user during a first interactive session. For example, a user uses client system 336 to access an interactive server that hosts the chatbot system 300. The user enters a prompt, such as prompt 328, into the client system 336 and the client system communicates the prompt 328 to the chatbot system 300. In some examples, the prompt 328 may include other types of data as well as text such as, but not limited to, image data, video data, audio data, electronic documents, links to data stored on the Internet or the client system 336, and the like. Regardless of the data type of the prompt 328, keyword attribution and expansion may be used to automatically generate a cluster of keywords or attributes that are associated with the received prompt 328. For example, image recognition may be deployed to identify objects and location associated with image data and to generate a keyword cluster or cloud that is then associated with the image-based prompt.

The prompt may furthermore be received through any number of interfaces and I/O components (e.g., the I/O components 1108) of a client system 102. These include gesture-based inputs obtained from a biometric component and inputs received via a brain-computer interface (BCI).

In operation 304, the chatbot system 300 generates, by the one or more processors, a response 370 based on the LLM 338 (LLM). For example, the 300 receives the prompt 328. The chatbot system 300 uses the LLM 338 to generate the response 370.

The chatbot system 300 generates a raw response 362 based on the prompt of the user, generates an adjusted input prompt 368 based on filtering the raw response 362, and generates a new response based on adjusted input prompt 368. The response filter component 340 uses a set of filtering criteria to eliminate specified content from the user feedback 360, for instance obscene words or concepts, or content that some may consider harmful. The chatbot system 300 generates adjusted input prompt 368 that is communicated to the LLM 338 as the prompt 328.

In some examples, the LLM 338 is hosted by the same system that hosts other components of the chatbot system 300. In some examples, the LLM 338 is hosted by a server system that is separate from the system that hosts the chatbot system 300 and the chatbot system 300 communicates with the LLM 338 over a network. For example, the chatbot system 300 receives the user prompt and communicates the user prompt to the LLM 338 residing on the separate system. The LLM 338 receives the prompt 328 and generates the raw response 362. The LLM 338 then communicates the raw response 362 to the chatbot system 300. The chatbot system 300 receives the raw response 362 for subsequent processing.

In some examples, the chatbot system 300 generates a set of potential responses and selects the response from the set of potential responses. In some examples, the chatbot system 300 communicates the potential responses to the client system 336 and the client system 336 displays them to the user and the user selects the response that is most applicable to the user's prompt.

In some examples, as part of the response 370, the chatbot system 300 generates a set of chatbot system prompts that are displayed to the user by the client system 336 and prompting the user to interact with the chatbot system 300. The chatbot system prompts generated by the chatbot system 300 may include context sensitive material, instructions to the user, possible topics of conversation, and the like. In some examples, the chatbot system 300 uses the chatbot system prompts to suggest chat topics to a user or to guide the user through a conversation, such as providing instructional material on various topics. In some examples, the chatbot system prompts comprise suggestions of conversations or questions that are intended to solicit a user to enter a user prompt. In such examples, the suggested chats are aimed at helping the user get to information they need, but provide a helpful side effect of generating additional user interactions with the chatbot system 300 from which intent can be inferred.

In operation 306, the chatbot system 300 determines a user intent 366 based on the user prompt 328 and response 370. For example, a logging component 350 receives prompt 328, potential responses 364, and response 370 and any follow up messages and communicates them to an intent processing component 348 that includes a parallel intent processing pipeline. This pipeline uses Natural Language Processing (NLP) methodologies to map sets of conversations to a set of intentful keywords and concepts. In addition to the keywords which are used in the original prompt, the stemmed keywords and expanded concepts are also generated. The platform also assigns a weight to each concept based on the importance of those in the conversation and their commercial weight. These keywords and concepts are aggregated and mapped to the user as part of an intent profile or intent vector having weighted keywords and concepts based on the importance of those keywords in the conversation.

In some examples, the chatbot system 300 collects a set of prompts, as exemplified by prompt 328, additional prompt 372, and additional prompt 330, during an interactive session. The chatbot system 300 maps the set of prompts to a set of keywords and/or concepts comprising a user intent vector, as exemplified by keywords 332 and concepts 334. The chatbot system 300 assigns weights to the keywords of the set of keywords and/or concepts based on an importance score to the conversation of the keyword and/or concept, and determines the user intent based on the user intent vector including the weighted keywords and/or concepts.

In some examples, the chatbot system 300 stores a conversation state in the user profile database 354 of a series of interactive sessions so that the chatbot system 300 can have a context for conversations that occur over a plurality of interactive sessions.

Any conversation data collected by the chatbot system 300 are captured and cached with only user approval and deleted on user request. Further, such conversation data may be used for very limited purposes, such as generation of responses by the chatbot system 300. To ensure limited and authorized use of conversation data and other PII, access to this data is restricted to authorized personnel only, if at all. Any use of conversation data may strictly be limited to chatbot purposes, and the conversation data is not shared or sold to any third party without the explicit consent of the user. In addition, appropriate technical and organizational measures are implemented to ensure the security and confidentiality of this sensitive information.

In some examples, the chatbot system 300 determines a personality or tone for the responses generated by the chatbot system 300. For example, the chatbot system 300 stores a conversation state for the user as part of the user's profile stored in the user profile database 354. The chatbot system 300 uses the conversation state and demographic or other information about the user to determine a personality or tone for the user, such as by adopting a formal tone for an older user, and a more informal tone for a younger user. A user may also have the ability to specifically alter the “persona” of interactions with the chatbot system by specifically requesting that the chatbot system 300 respond or act in a specific way (e.g., “be funnier”, “answer in riddles” etc.). In addition to modifying the personality or tone of the responses, the visual interface presented by the chat system 300 may also be altered to reflect a specific “persona” of the chatbot system 300. In some examples, a slide toggle may be presented to enable a user to select between a menu of persona traits (e.g., “cheeky”, “wry”, “cute”, etc.)

In some examples, the chatbot system 300 associates a temporal time factor to a keyword or concept where the temporal time factor decays in time. For example, the chatbot system 300 attaches a temporal time factor to the keywords and concepts, which indicates how fresh that concept should be used for targeting and bidding. For example, “Hotels in Cancun for spring break” vs “Planning for wedding next year” will have two different decaying factors. In some examples, the chatbot system 300 applies a temporal time factor to a conversation state.

In some examples, an overall user intent is built using various signals or data such as user demographics, location, device, engagement with organic surfaces of an interactive platform or features of an interactive platform application and consumption patterns, and overall friend-graph proximity carrier signals or data that may be discernable from the user's affiliation with the interactive platform.

In some examples, the intent vector is an additional dimension which will be used to refresh and update an intent profile stored in the user profile database 354.

In some examples, the chatbot system 300 uses a user profile 376 from a user profile database 354 that includes interactive platform data of the user.

In some examples, the chatbot system 300 generates the advertising content 358 using an interaction by the user with previously provided advertising content where the interaction is captured during a second interactive session. For example, the chatbot system 300 is a component of an interactive platforming system that provides the advertising content 358 to the user in the context of the user's interactions with the interactive platforming system outside of the user's interaction with the chatbot system itself. The chatbot system 300 receives data of the user's interaction with the advertising content 358 in an advertisement analytics database 344 and uses the data of the user's interactions to determine how effective the intent processing component 348 was in determining the user's intent.

In some examples, the intent processing component 348 uses artificial intelligence methodologies including Machine Learning (ML) models to generate the user intent 366. The chatbot system 300 uses the data on user intent and conversation context to improve its targeting and optimization capabilities over time by ingesting the feedback. The chatbot system 300 collects engagement of the user on ads, organic surfaces or features of the interactive platforming system and also responses to the chatbot system 232 itself and feeds that into the intent processing component 348. Accordingly, the chatbot system 300 can finetune or further pre-train the ML models of the intent processing component 348 to not only take user intent into consideration, but also use follow up actions to finetune the user intent inference model.

In operation 308, the chatbot system 300 determines advertising content 358 based on the user intent 366 and the response 370 as more fully described in reference to FIG. 3D.

In operation 310, the chatbot system 300 communicates to the client system 336, the advertising content 358 during a second interactive session. For example, the user interacts with an interaction system 100 (of FIG. 1) of an interactive platform and accesses some additional features of the interactive platform. As the user interacts with the interaction system 100, the interaction system 100 provides the advertising content 358 outside of the initial interactive session where the prompts were received and the responses generated.

In some examples, the system that hosts the chatbot system 300 may not be a component of an interactive platform but another interaction system that provides services and information to a group of users such as, but not limited to, a platform that provides enterprise wide connectivity to a group of users such as employees of a company, clients of an enterprise provided professional services, educational institutions, and the like. In some of such examples, the content provided to the users may not be advertising, but may be other types of useful information such as company policies, status messages for projects, newsworthy events, and the like.

In some examples, end-to-end encryption is used to secure communications thus ensuring that only the sender and the intended recipient can read the messages being exchanged. By implementing end-to-end encryption, the chatbot system 300 can provide a secure and private messaging experience for users while still extracting intent for advertising experience enhancement. In the context of user intent extraction, this means that once the conversation is end-to-end encrypted, the chatbot system 300 as an end of the conversation can decrypt messages and pass those to the intent extraction pipeline of the intent processing component 348.

In some examples, the chatbot system 300 is operatively connected to an Internet search engine or the like and the user can use the chatbot system 300 as an intelligent search engine to search the Internet.

In some examples, the chatbot system 300 is operatively connected to a proprietary database and the user can use the chatbot system 300 as an intelligent search assistant for searching the proprietary database.

In some examples, the LLM 338 is continuously retrained using information about advertising content 358 stored in the advertising and campaigns database 346. For example, the LLM 338 is trained on the latest products being offered by advertisers on the interaction system 100 and offers product information on those products in response to requests by a user for the newest model of particular product categories.

In some examples, the LLM 338 is continuously retrained or finetuned based on user interactions with the advertising content 358. For example, the interaction system 100 collects advertising content engagement metrics and stores the metrics in the advertisement analytics database 344. The metrics are then used to provide reinforcement to the LLM 338 when the LLM 338 provides a sequence of responses that lead to a successful user intent determination and consequently properly targeted advertising content 358 that the user interacted with.

In some examples, the chatbot system 300 uses conversations between users and other chatbots as inputs into the intent processing component 348. The other chatbots can be sponsored chatbots, custom chatbots built by users from self serve tools/templates, and the like.

In some examples, a number of messages that the chatbot system 300 can receive after the chatbot system 300 enters a conversation are limited in number, limited in time that the chatbot system 300 may retain the messages and/or limited in a scope of what the chatbot system 300 can do with the messages. In some examples, the chatbot system 300 explicitly indicates that the chatbot system 300 has joined a conversation in the interests of transparency. In some examples, the chatbot system 300 provides a disclosure regarding what is being shared, both via a presence indicator and/or other chat affordances. In some examples, the disclosure includes a statement that the chatbot system 300 is receiving messages in order to improve services provided to the users.

In some examples, the information that the chatbot system 300 extracts from conversations is focused on the user intent. In addition, the chatbot system 300 furthers a conversation with a user by knowing that user intent (e.g., if the user asks for good hotels in Cancun, the chatbot system 300 responds with: “Here is a list of hotels. I also know of a good promotion for a hotel, would you like to see it?”). This provides for the user intent being extracted from the user, matching the intent to possible ads, and embedding that knowledge into a response. In some examples, the chatbot system 300 augments response with a “popular with friends” list.

In some examples, textual components of ads are used to finetune the responses of the LLM 338 conditioning the responses of the LLM 338. This improves the suggestions the chatbot system 300 and improves user engagement.

FIG. 3D is an illustration of a process flow diagram of an advertising creation process, according to some examples. A chatbot system 300 uses the advertising creation process to create advertising content 358 that is provided to a user outside of the context of an interactive chat session.

In operation 312, the chatbot system 300 receives, from an advertiser, a landing page website or application for analysis. For example, the chatbot system 300 receives a landing page website or application from an advertiser. This landing page or application contains up-to-date and accurate information about the advertiser's product or service offering. The chatbot system 300 analyzes the received landing page/application using natural language processing techniques to extract useful details like product features, visual assets, and branding elements. The chatbot system 300 extracts this information so it can later generate targeted and relevant advertising creatives that accurately reflect the advertiser's offering. By receiving and analyzing the advertiser's own landing page/application, the chatbot system 300 is able to create customized ad content that is aligned with the advertiser's messaging and branding.

In operation 314, the chatbot system 300 receives, from the advertiser, additional media assets such as images and videos. For example, the chatbot system 300 receives additional media assets like images and videos from the advertiser in operation 314. By obtaining these supplemental visual media assets directly from the advertiser, the chatbot system 300 can incorporate elements that authentically represent the advertiser's brand identity and product offering. The chatbot system 300 analyzes the received images and videos using computer vision techniques to identify relevant visual components. These components, such as product imagery, brand logos, and video testimonials, provide additional creative elements that the chatbot system 300 can integrate when generating customized advertising content for the advertiser. By sourcing authentic brand imagery and videos from the advertiser, the chatbot system 300 is equipped to produce compelling ad creatives that resonate with the advertiser's target audience.

In operation 316, the chatbot system 300 receives, from the advertiser, additional context such as product specifications, product catalogs, and other relevant assets. For example, the chatbot system 300 receives additional context like product specifications, product catalogs, and other relevant assets from the advertiser in operation 316. By obtaining supplemental information directly from the advertiser, the chatbot system 300 can better understand the full capabilities and value proposition of the advertiser's offering. The chatbot system 300 analyzes the received product details and catalogs using natural language processing to identify key attributes and messaging. These insights, such as technical specifications, usage scenarios, and benefits, allow the chatbot system 300 to craft advertising copy and creatives that accurately capture the essence of the product or service. By sourcing relevant contextual information from the advertiser, the chatbot system 300 can generate ads with messaging and visuals tailored to promote the unique selling points and differentiators of the offering. The additional context equips the chatbot system 300 to produce ads that resonate with the target audience.

In operation 318, the chatbot system 300 receives, from the advertiser, a selection from a variety of potential directional themes and templates for creating advertising creatives. For example, the chatbot system 300 receives a selection of potential directional themes and templates for creating advertising creatives from the advertiser. By allowing the advertiser to choose from different creative themes and templates, the chatbot system 300 aligns the visual style and messaging tone of the generated ads to the advertiser's brand and goals. The advertiser's selection provides guiding creative direction to the chatbot system 300 as it assembles visual, textual, and contextual components into advertising creatives. With the advertiser's input on preferred themes and templates, the chatbot system 300 can produce customized ads that adhere to the look, feel, and messaging that the advertiser aims to project in their marketing campaigns. The chosen creative direction steers the chatbot system 300 to generate ads with designs, layouts, and copy that help the advertiser's content resonate with their target audience.

In operation 320, the chatbot system 300 receives, from the advertiser, target keywords and concepts. For example, the chatbot system 300 receives target keywords and concepts from the advertiser in operation 320. By obtaining specific keywords and concepts directly from the advertiser, the chatbot system 300 can incorporate messaging into the generated ads that is directly relevant to the advertiser's offering and target audience. The chatbot system 300 analyzes the received keywords using natural language processing to identify key messaging themes. These targeted keywords and expanded concepts allow the chatbot system 300 to produce ad copy and creatives that contain the precise terminology and messaging to effectively reach and resonate with the intended audience. The advertiser-supplied keywords and concepts provide the chatbot system 300 with the exact language needed to craft compelling ads tailored to promote the advertiser's product or service to the desired customer segments.

In operation 322, the chatbot system 300 extracts potential additional assets and metadata from the destination website or application, and takes into consideration the input keywords and concepts. For example, the chatbot system 300 extracts potential additional assets and metadata from the advertiser's website or application and considers the input keywords and concepts in operation 322. By programmatically analyzing the advertiser's digital presence, the chatbot system 300 can discover supplemental creative elements like images, videos, and text content. The chatbot system 300 leverages computer vision, natural language processing, and data mining techniques to identify relevant components from the website and app. These extracted creative assets and metadata, combined with the advertiser's supplied keywords and concepts, equip the chatbot system 300 with a robust set of components to assemble compelling, on-brand advertising creatives. By algorithmically harvesting assets from the advertiser's channels, the chatbot system 300 can generate customized ads tailored to promote the advertiser's brand and offering.

In operation 324, the chatbot system 300 uses a creative generation component 356 to generate a series of advertising content creatives based on this information. For example, the creative generation component 356 of the chatbot system 300 utilizes all of the collected information and assets to automatically generate a set of advertising content creatives. Specifically, the creative generation component 356 leverages the product details, brand guidelines, target keywords, creative direction, and digital assets gathered in previous operations to algorithmically produce multiple versions of ads tailored for the advertiser. Using advanced generative AI techniques, the creative generation component 356 synthesizes unique combinations of images, text, logos, and layouts into customized advertising creatives that align with the advertiser's brand, products, and target audience. By bringing together all of the inputs provided by the advertiser along with extracted metadata and assets, the creative generation component 356 can efficiently and automatically generate high-quality, on-strategy advertising creatives on behalf of the advertiser.

In operation 326, the chatbot system 300 modifies delivery of advertising content based on user engagement with the advertising content. For example, the chatbot system 300 modifies the delivery of advertising content based on user engagement with the ads. Specifically, the chatbot system 300 tracks metrics such as click-through rates, conversion rates, and dwell time for the generated ads. Using this engagement data, the chatbot system 300 can determine the highest performing ads and optimize the ad delivery accordingly. For example, ads with higher click-through or conversion rates may be shown more frequently or to broader audiences. Conversely, lower performing ads may be shown less or stopped altogether. The chatbot system 300 can also iterate on ad creative, copy, placement, etc. based on observed user engagement patterns. By leveraging user feedback and advertising performance data, the chatbot system 300 refines both ad creation and ad delivery to maximize results for the advertiser. This allows the system to automatically optimize campaigns and serve ads that resonate best with target users.

In some examples, the chatbot system 300 uses an advertising content delivery and bidding component 352 to provide advertisers an opportunity to bid on certain actions by choosing keywords or an expanded set of concepts (auto expansion) to select their potential target audience and display advertising content 358 that will be delivered to users who match that criteria within their intent vector. Overall, by mapping conversations to a set of keywords and concepts and attaching a temporal time factor to them, and finally mapping those to user intent and profile, the advertising content delivery and bidding component 352 of the chatbot system 300 enables advertisers to find their target audience much more precisely.

In some examples, the chatbot system 300 includes an ad targeting component 378. The ad targeting component 378 The ad targeting component utilizes the user intent and interests extracted from conversations with the chatbot system 300 to target and deliver relevant ads to users. For example, the ad targeting component 378 analyzes the user intent vector comprising weighted keywords and concepts determined by the intent processing component 348. It matches these keywords and concepts to target criteria specified by advertisers for their ad campaigns stored in the advertising and campaigns database 346. Ads are ranked based on the degree of match between the user intent vector and the advertiser targets. Ads with higher relevance are prioritized for delivery. The ad targeting component also considers other targeting parameters like user demographics, location, and platform engagement history from the user profile database 354. Additionally, the ad targeting component 378 tracks user engagement with delivered ads using feedback stored in the advertisement analytics database 344. The ad targeting component 378 optimizes ad targeting over time by determining which ads drive higher engagement for which user intents.

In some examples, the chatbot system 300 includes an ad ranking component 380. The 380 The ad ranking component 380 determines a priority and order in which ads are shown to users of the interactive platform. The ad targeting ad ranking component 380 uses user intent from chatbot conversations to deliver highly personalized, relevant ads to each user.

In some examples, the ad ranking component 380 ranks and scores ads using various criteria such as, but not limited to:
Relevance to the user's intent vector—Ads are ranked higher if they closely match keywords/concepts the user expressed interest in during chatbot conversations.
Expected engagement—Ads are scored based on historical click-through rates, conversion rates, and dwell times for different user intents.
Bid amount—Advertisers can bid for specific keywords/concepts. Higher bids influence ad rank.
Landing page relevance—The ad's landing page is analyzed for relevance to the user's intent. More relevant landing pages increase ad rank.
Advertiser budget—Ad rank considers the remaining budget of the advertiser's campaign.

In some examples, the ad ranking component 380 combines one or more factors using a machine learning model to assign a final rank score to ads. The ad ranking component 380 selects the top ranking ads to show to each user.

In some examples, the ad ranking component 380 continuously monitors engagement with ranked ads and refines the model to improve ranking accuracy over time. This allows the most relevant ads to be surfaced to users based on their conversational intents with the chatbot system.

In some examples, the ad ranking component 380, can expand or narrow down targeting as it learns which concepts map better to user responses.

In some examples, an AI-driven ad creative generation component 356 of the chatbot system 300 assists advertisers by simplifying the process of creating advertising creatives. By providing inputs such as website, target application, additional assets, and target keywords, the chatbot system 300 can automatically generate ad creatives. This can save advertisers time and resources, allowing them to focus on other aspects of their advertising campaigns.

In some examples, the chatbot system 300 utilizes machine learning methodologies to optimize the advertising content 358 creatives over time. The chatbot system 300 tests multiple permutations of the generated advertising content 358 to determine which permutations work better. Such a process will be more applicable to dynamic product ads which are generated based on a dynamic catalog stored in advertising and campaigns database 346. This improves advertising performance and increases the chances of success, ultimately providing a better return on investment for the advertisers. The chatbot system 300 not only saves time and resources for the advertisers but also increases the chances of success by providing the most relevant and effective advertising content 358 creatives for the target audience.

In some examples, the chatbot system 300 measures similarity of expanded concepts of a conversation with a user with advertiser ad concepts or contexts. This allows the advertisers to not only use specific words, but also sentences and descriptions for what they are looking to promote. In some examples, the ad relevance is a distance between ad concepts or contexts and the expanded concepts of the conversation.

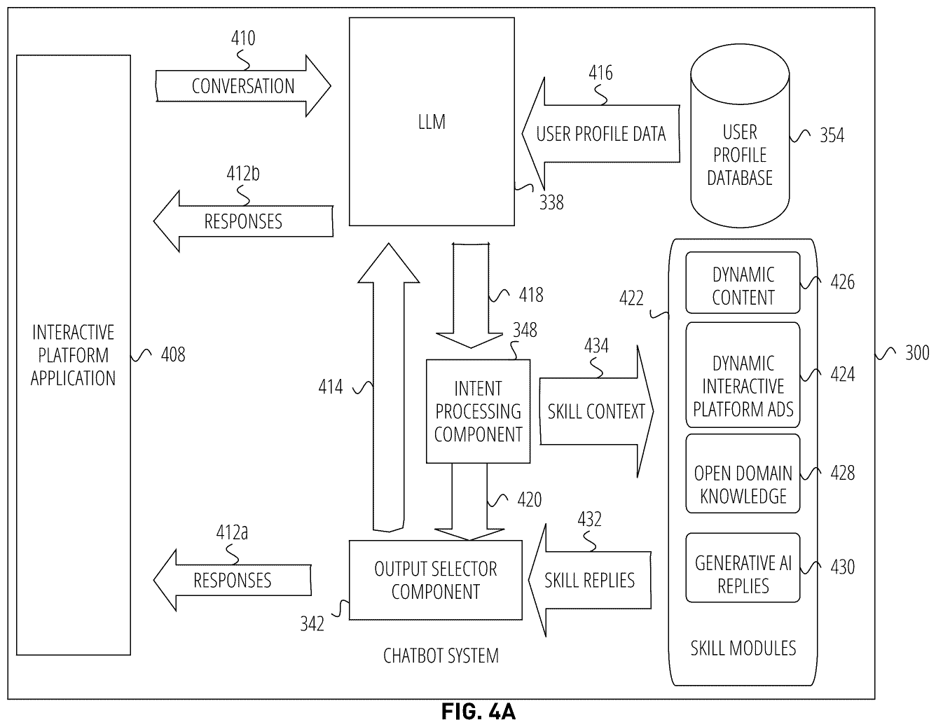

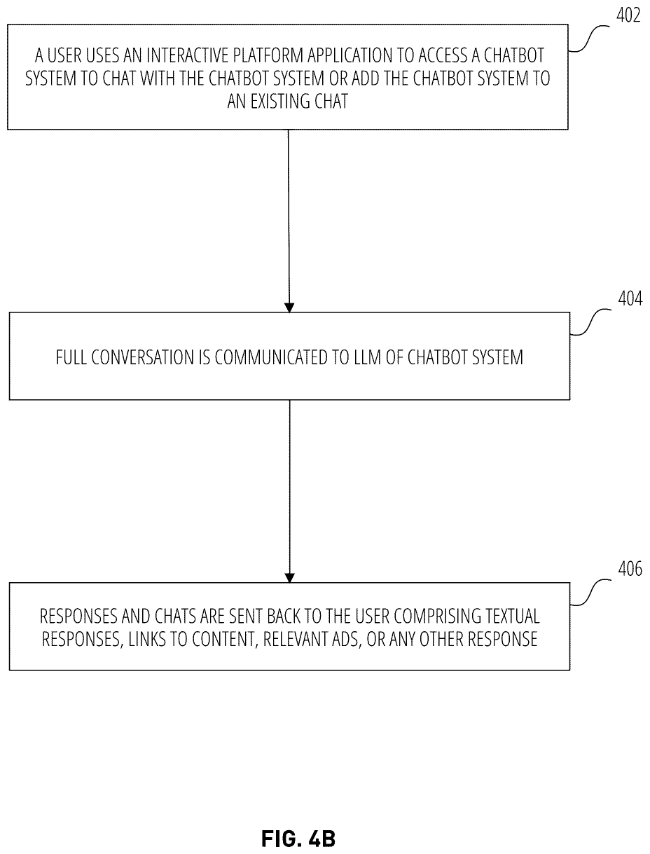

FIG. 4A is a tech block diagram of a chatbot system 300 (of FIG. 3A), and FIG. 4B is an activity diagram of a method of the chatbot system 300, according to some examples.

In operation 402, a user uses an interactive platform application 408, such as application 106 executing on a client system 102 (of FIG. 1), to access the chatbot system 300 so that the user can chat with the chatbot system 300 or add it to existing chats. For example, the user utilizes the interactive platform application 408 to access the chatbot system 300, enabling the user to directly chat with the chatbot system 300 or add it to existing conversations. The interactive platform application 408 provides the user interface through which the user can interact with the chatbot system 300. Within the interactive platform application 408, the user has the option to initiate a 1-on-1 chat session with the chatbot system 300 or bring the chatbot system 300 into a group chat or messaging thread. This gives the user flexibility to engage the chatbot system 300 for personalized dialogue or within the context of ongoing discussions with other users. From the interactive platform application 408, the user can send textual prompts to the chatbot system 300 and receive conversational responses. By accessing the chatbot system 300 through the interactive platform application 408, the user can leverage the chatbot's capabilities to obtain information, recommendations, and other services through natural conversation flows.

In operation 404, the full conversation 410 is communicated to the LLM 338. For example, the entire conversation between the user and the chatbot system 300 is communicated to the Large Language Model (LLM) 338. This provides the LLM 338 with the full context of the interactive dialog, including the initial prompt from the user as well as any follow-up messages. By analyzing the complete exchange comprising the full conversation, the LLM 338 can better understand the intent and meaning behind the user's queries. Additionally, having access to the full conversation flow enables the LLM 338 to maintain continuity and generate responses that logically follow from previous parts of the dialog. This conversational context allows the LLM 338 to produce more natural, relevant responses compared to only looking at individual messages in isolation. Feeding the complete back-and-forth conversation to the LLM 338 empowers it to have a more holistic understanding of the interaction and in turn generate superior responses.

In operation 406, responses 412a and chats are sent back to the user, from the output selector component 342, which can include textual responses, links to content, relevant ads, or any other response. For example, the output selector component 342 determines the most appropriate type of response to return, which could include textual responses, links to relevant content, ads targeted to the user's interests, or any other suitable response. In some examples, the output selector component 342 may decide a textual response is most fitting for a factual question, while an ad for a product or service may be most relevant for a commercial query. The output selector component 342 chooses among the available response types to provide the user with the most useful, tailored information. By supporting multiple response formats like text, links, and ads, the chatbot system 300 can dynamically serve the user with the most fitting type of reply for each conversation turn. This allows the chatbot system 300 to have a diverse, engaging dialogue with the user.

In some examples, a more detailed textual response is generated by the chatbot system 300 beyond a short reply. To do so, the LLM 338 generates a longer, more elaborate response. The output selector component 342 provides additional context 414 to the LLM 338 to help construct this longer response. For example, the output selector component 342 may supply conversational history, user profile data, or other supplementary information to give the LLM 338 more context. Equipped with this extra context, the LLM 338 is able to produce a richer, more natural sounding lengthy response. The output selector component 342 determines when the dialog requires more elaboration and leverages the LLM 338's capabilities to generate articulate, contextual responses of multiple sentences or paragraphs in length. This allows the chatbot system 300 to handle user queries that demand more than just a short, simple response.

In some examples, the LLM 338 is fine-tuned to conduct conversations in the context of the interactive platform hosting the chatbot system 300, taking into account additional user profile data 416 from a user profile database 354. The LLM 338 is customized to incorporate details from the user's profile on the interactive platform, such as their demographics, interests, and past activity. This allows the LLM 338 to have a basic understanding of who the user is and tailor its responses accordingly. In some examples, the LLM 338 is adapted to leverage the additional context 414 signals that may be relevant to the conversation on the interactive platform. This includes factors like the user's friends, location, time of day, and recent interactions on the platform. By factoring in these contextual clues, the LLM 338 can generate more situational and personalized responses. By fine-tuning the LLM 338 using profile data and additional context from the interactive platform, the chatbot system 300 can produce conversations that are more natural, intuitive, and engaging for users within the specific environment of the interactive platform. This platform-optimized training helps address user needs and expectations for conversations on the interactive platform.

In some examples, the LLM 338 responses 418, together with the LLM 338 context (conversation embedding) and additional context such as initial intent from the LLM 338 are sent to the intent processing component 348. The intent processing component 348 defines skill context 434 and details (for example keywords), to different relevant skill modules 422 and detects the user intent, and conversational state 420. For example, the intent processing component 348 analyzes the conversation between the user and the chatbot system 300 to extract important keywords, entities, and details. It passes these context clues to various skills modules that can generate relevant responses. Additionally, the intent processing component 348 leverages machine learning models to infer the user's true intent and state of the conversation from the contextual signals. For instance, the output selector component 342 detects whether the user is asking about purchasing diapers or requesting a Wikipedia definition. By extracting conversation details and detecting user intent, the intent processing component 348 enables downstream components to produce responses tailored to the user's needs.

In some examples, the skill modules 422 include a dynamic content module 426. The dynamic content module 426 provides relevant, personalized information to users during a conversation by leveraging various data sources and generative techniques. Some examples of dynamic content operations comprise:
Retrieving user-specific data like preferences, purchase history, calendar events, and the like to provide customized responses.
Generating personalized recommendations for products, services, content, and the like tailored to the user.
Synthesizing relevant news articles, social media posts, weather reports, and the like on topics discussed.
Creating dynamic visualizations such as charts, graphs, maps, and the like on-the-fly to visualize data requested by the user.
Generating custom imagery or multimedia to illustrate points in the conversation.
Producing audio clips with relevant sound effects, background music, and the like to engage the user.
Integrating with APIs, databases, websites to fetch up-to-date information as needed.
Adapting responses to reflect latest offers, deals, pricing for products, and the like based on live data.
Updating responses with real-time data like sports scores, stock prices, traffic, and the like.
Synthesizing previous parts of the conversation into summaries to provide context.

The dynamic content module 426 taps into various data sources and generative models to create unique, personalized, dynamic content on the fly during a conversation. This makes the dialogue more engaging and relevant for each user.

In some examples, the skill modules 422 comprise a dynamic interactive platform ads module 424. The dynamic interactive platform ads module 424 provides relevant, targeted advertisements to users during a conversation. Operations of the dynamic interactive platform ads module 424 comprise:
Analyzing the conversation context and user profile to determine user interests and intent.
Using this understanding of user intent to retrieve and rank relevant ads from an ad inventory.
Generating personalized ad copy and creatives on the fly tailored to the user.
Dynamically inserting highly relevant ads at appropriate points in the conversation.
Adapting ad creative elements like images, videos, audio to match conversation context.
Updating ads with latest pricing, deals, offers pulled from live ad data.
Pulling real-time performance data to optimize ad targeting and improve relevance.
Providing interactive ad experiences like mini-games, polls, special offers etc.
Enabling users to provide feedback on ads to further refine targeting.
Measuring ad engagement, clicks, conversions to evaluate and improve ad performance.
Following platform advertising policies and complying with user preferences.

The dynamic interactive platform ads module 424 taps into user intent, conversation context, and ad data to deliver highly dynamic, personalized, and relevant ads within the conversational experience. This benefits users with ads they want to see as well as advertisers reaching the right customers.

In some examples, the skill modules 422 comprise an open domain knowledge module 428. Operations of the open domain knowledge module 428 comprise:
Answering factual questions by searching knowledge bases like Wikipedia, Wikidata, DBpedia etc.
Providing definitions, explanations, and descriptions of concepts the user asks about.
Summarize key information from long articles, papers, or passages relevant to the user's queries.
Generating visual aids like info-graphics, charts, timelines, maps to illustrate complex topics.
Enabling clarifying follow-up questions from the user to refine their information needs.
Ranking and filter responses to provide the most relevant, helpful information to the user.
Citing sources and link out to original references for transparency.
Leveraging large language models pre-trained on massive text corpora to generate informative responses.
Ingesting new information from various structured data sources.
Asking users for feedback to improve the quality of information provided.
Following ethical guidelines around information accuracy, attribution, and reliability.

The open domain knowledge module 428 provides users with informative, trustworthy, and useful information on any topic they inquire about by tapping into open data resources in a responsible manner. The goal is to enhance the conversational experience with the knowledge of the world.

In some examples, the skill modules 422 comprise a generative AI replies module 430. Some operations of a generative AI replies module 430 comprise:
Generating natural language responses to user inputs using large language models like the LLM 338
Allowing open-ended discussions on a wide range of topics beyond just questions and answers.
Maintaining context and consistency across multiple turns of a conversation.
Exhibiting personality and emotional intelligence through word choice and tone.
Providing nuanced, non-repetitive responses tailored to each user input.
Incorporating world knowledge from pre-training corpora into responses.
Enabling mixed-initiative conversations where both the user and AI contribute.
Dynamically adjusting reply style, length, depth based on user preferences.
Seamlessly integrating with other modules like speech, vision, knowledge etc.
Learning from user feedback and conversations to improve over time.
Ensuring responses meet platform content policies and community guidelines.
Attributing sources when incorporating external information into responses.
Indicating when responses are speculative vs factual.

The generative AI replies module 430 leverages AI to produce human-like, engaging conversations that adapt to each user and conversation context while meeting interactive platform policies.

The various relevant skill modules 422 return skill replies 432 as potential responses 364 (0f FIG. 3A) to continue the conversation 410, which may include suggestions for dynamic content, relevant ads, open domain responses, and more following the output of the above skill modules. The skill replies 432 are sent back to the output selector component 342 as potential responses 364.

The output selector component 342 determines which response is more appropriate to s current stage of the conversation 410, and either returns the skill replies 432 to the LLM 338 for natural answer generation, or uses the responses 412a and 412b already generated and returns them directly to the interactive platform application 408 and the user.

In some examples, the LLM 338 is fine-tuned toward chatting in approved an interactive platform's approved chat styles, providing safe responses, respecting interactive platform values, providing multiple persona traits as described above, incorporating user context, and/or previous conversation history and optionally returning high level intents.

In some examples, the intent processing component 348 is based on an AI component such as a neural net or the like, and/or business logic designed to determine significant interactive platform intents (for example, information seeking, game playing, chit chat and more) and their attributes (information seeking-Baby diapers alternatives). The model is trained on extracting the intents from the LLM 338 context, or other embeddings of the conversation and conversation history. In addition to the model, simpler models such as keyword extraction, and categorization can be applied to enrich the intent details. The intent processing component 348 provides these details to the various skills skill modules 422. In some examples, the skill modules 422 are a set of parallel modules each designed for returning a response based on separated abilities and concerns. For example, a dynamic interactive platform ads module 424, given the intent and details, re-ranks and select the most appropriate ad to place as a result, whereas the generative AI replies module 430, given the intent and context would generate a multi-media result using the generative AI capabilities.

In some examples, not all of the skill modules are necessarily be used for each intent but for some intents several modules may be used generating several alternatives for response. The output selector component 342 applies the business logic to select the most appropriate results at each turn, according to the business policy, their relative effectiveness and other metrics.

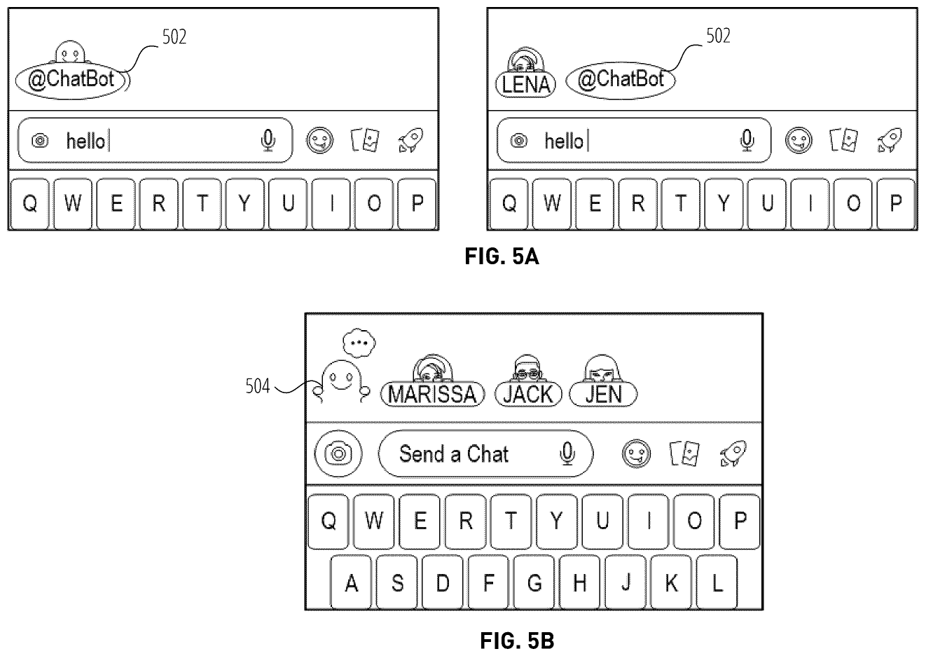

FIG. 5A and FIG. 5B are illustrations of user interfaces, according to some examples. A chatbot system 300 (of FIG. 3B) uses the user interfaces to communicate that the chatbot system 300 is active and available for interactions with users and may be acquiring information about a user's interaction with an interactive platform. User interactions with the chatbot system 300 may be multimodal. In some examples, the user may interact with the chatbot system 300 directly by exchanging user prompts and chatbot responses directly. In some examples, two or more users may interact with one another while the chatbot system 300 monitors the interaction in order to discern user intent of one or more of the users. In some examples, the chatbot system 300 is made available to a user in a user interface for invocation during a chat session with another user.

In some examples, the chatbot system 300 shows that the chatbot system 300 is listening to a conversation by adding a chatbot icon 502 as a member of the chat in a presences bar (i.e., alongside Bitmojis of friends, a character). In some examples, the chatbot system 300 provides a chatbot icon 504 to represent the chatbot system 300 as a member of a chat using an avatar. A user taps the chatbot icon 504 on the presence bar to start asking the chatbot system 300 a question or writes @ChatBot in the chat bar. In some examples, the 300 uses an “X is typing”-style visual as a loading indicator while the chatbot system 300 prepares a response to a query. In some examples, a user uses “@” to add the chatbot system 300 to a Chat and directly summons the 300 to help with a query.

In some examples, a user learns about, creates, and gets help with just about anything during an interactive session with the chatbot system 300. In some examples, the interactive session is a private interactive session with the chatbot system 300. In some examples, the interactive session includes one or more other users and one or more users ask the chatbot system 300 for help directly during the interactive session. In some examples, the chatbot system 300 provides assistance to a user in accessing different features of an interactive system hosting the chatbot system 300 or another interactive system or Internet locations.

In some examples, the chatbot system 300 helps a user in the same way an intelligent friend would, such as by communicating directly with a user and a user's friends directly using a chat interface and by sending social media content and other content directly to the user.

In some examples, a user utilizes the chatbot system 300 as a primary user interface with the interactive system hosting the chatbot system 300. As the chatbot system 300 infers the user intent from interactions with the user and has a conversation state that is saved, the chatbot system 300 also infers what a user is interested in interested in based on what the chatbot system 300 learns from the chats it has access to (including 1:1 chat threads with the chatbot system 300), a user's general usage of the interactive system hosting the chatbot system 300, other third-party communications with the user, how the user communicates, who the user's friends are, as well as those friends' user intents, profiles, geographic location(s), interests, and the chatbot system 300 helps the user learn about, create, and engage in new activities.

In some examples, the chatbot system 300 influences the content the user sees across the interactive system that hosts the chatbot system 300 and in chats where the chatbot system 300 is a participant. For example, if a user asks about fun games to play with the user's baby, the chatbot system 300 may suggest newborn advice videos on a content platform or recommend an ad for a baby product.

In some examples, the chatbot system 300 can send any kind of content that a user of the interactive platform hosting the chatbot system 300 can send such as, but not limited to, chats, any type of media such as images, videos, audio recordings, social network posts, chat media, web links, map places, AI-generated media, media from the user's own datastore, and the like.

In some examples, implementation of the chatbot system 300 in a conversational interface integrated within an interactive application provides messaging, content, and display advertisements (including AI-generated ads based on keyword winning links) which also helps provide signals for ranking of all content provided by the chatbot system 300 (including display advertisements, media, and AR).

In some examples, interactions with the chatbot system 300 across all features of the interactive system that hosts the chatbot system 300 improves the LLM 338 over time. Interaction data collected and used to train the LLM 338 include, but are not limited to, what is asked, follow-up questions, in application reporting of answers, in-application reactions to answers, forwarding of answers, sharing of answers, retention, frequency of use, .ad interactions, other searches, other actions, visual content of social network media content, camera rolls, user datastores of interactive application interactions, and the like.

In some examples, the chatbot system 300, through retraining of the LLM 338, provides for interactive system wide, per-user, and individual conversation training. In some examples, the LLM 338 is trained as part of a system-wide model based on all interactive system interactions. In some examples, the LLM 338 is trained in a per-user and even per conversation model (i.e., “what should I/we do today” yields different results for different people and for the same people asking it in different conversations).

In some examples, the chatbot system 300 provides suggested chat topics as chatbot system prompts, both before and after answering a question. For example, the chatbot system 300 provides the chatbot system prompts of what a user may say or do next. Tapping the suggestion prompts sends resends them to the chatbot system 300 as new user prompts.

In some examples, the chatbot system 300 provides a mixed or multi-modal chat session as an interactive session. For example, the chatbot system 300 infers when to send a user plain text chat data and when other kinds of media are required to satisfy a user's request. In some examples, a user may send user prompts to the chatbot system 300 silently within an existing interactive session with one or more other users. In some examples, the chatbot system 300 provides the user the ability to send requests to the chatbot system 300 within a conversation without other participants seeing questions or answers unless the user chooses to make those interactions visible.

In some examples, the chatbot system 300 provides the ability for a user to modify the personality of the chatbot system 300 such as, but not limited to, receiving an explanation of how the user wants the chatbot system 300 to act directly, alter the persona based on how the user prefers to communicate and how the user's friends communicate with the user, providing a visual interface to alter the persona of the chatbot system 300, use user profile information such as age, location, and content preferences to alter the persona, and the like.

In some examples, the chatbot system 300 provides for the reporting of answers in chat using chat reporting features of the interactive system hosting the chatbot system 300, and using the reporting to improve the LLM 338 by letting users provide the right response.

In some examples, the chatbot system 300 provides for assigning accuracy scores to users who provide feedback.

In some examples, the chatbot system 300 provides for human review of most asked for topics. In some examples, the chatbot system 300 provides a verified answer framework.

In some examples, the chatbot system 300 provides for personality moderation of response such as “I don't feel like I know for sure, but I think the closest answer I can give you is . . . . ”.

In some examples, the chatbot system 300 provides for confidence scoring of responses used to modify the way the chatbot system 300 generates a response, such as “Hmm, it's not 100% but my best bet is . . . .”

In some examples, the chatbot system 300 provides for solo or private interactive sessions and a user may provide user prompts on topics such as, but not limited to, relationship advice, finding content, homework help, general learning, fashion, connect verbal chat requests to a visual search database, and the like.

In some examples, the chatbot system 300 provides an eCommerce front end by allowing for verbal or text user prompts to search for products or services, (e.g., “Nissan Ultra 2012 under $15k”, best car for newborns).

In some examples, the chatbot system 300 provides for a quick search by receiving a short query that is extrapolated out to a more detailed query (e.g., “Nike history” extrapolated into questions automatically like: “100 words on how Nike started”, “What did Nike's leaders have in common?”) based on queries an interactive platform's community have provided as user prompts.

In some examples, the chatbot system 300 provides for a user interacting with one or more other users and the chatbot system 300 together and the chatbot system 300 responding with a context sensitive response (e.tg, “pick someone to cook tonight!”, “write a story about our friendship”, “find somewhere close by all of us for breakfast on Thursday”).

In some examples, the chatbot system 300 provides for a user to program a chat based application or function using verbal commands (e.g., create an account that is all about positivity and send the user inspirational quotes”.

In some examples, the chatbot system 300 provides the ability to easily forward responses of the chatbot system 300 to other interactive sessions with clear attribution.

In some examples, the chatbot system 300 provides the ability to export a photo or video of a conversation as part social network media, including with a watermark.

In some examples, the chatbot system 300 provides a sped up timelapse style of question and answer being typed out.

In some examples, the chatbot system 300 provides the user the ability to choose different styles.

In some examples, the chatbot system 300 caches other user prompts and responses and suggests user prompts and/or responses based on what a user is entering as a current user prompt and the cached user prompts and chatbot system 300 responses.

In some examples, the chatbot system 300 provides the ability for users to see user prompts entered by friends as suggestions. A user taps the previous user prompts to see who asked it and what the response was. In some such examples, a user may react and leave comments).

In some examples, the chatbot system 300 provides comments on answers by users with a “factcheck” for other users to see.

In some examples, the chatbot system 300 provides for the sharing of results of queries regarding social media by sharing a typing video of the question and answer OR recording over visual overlay of Q&A responses with a images of a user's reaction (still or video) in different styles (or add a memory or color/asset/generative media item as a background instead of a live camera).

In some examples, the chatbot system 300 provides the user with the ability to send social media posts to get edits and sometimes responses.

In some examples, the chatbot system 300 provides a user with the ability to send a social media post to the chatbot system 300 (including with a text question) using an in-chat camera where a text field is up by default on a preview.

In some examples, the chatbot system 300 receives a user prompt from a user in a form of a request to produce an image or video.

In some examples, the chatbot system 300 provides users with the ability to name friends and use their cameos (or other likeness) to produce artificial intelligence media (e.g., “me and @chuckie_mills on a boat in Barbados”).

In some examples, the chatbot system 300 provides the user the ability to send social media posts to the chatbot system 300 with instructions (e.g., “make these all have balanced lighting”, “combine these two faces, make this one funnier”).

In some examples, the chatbot system 300 provides the user the ability to combine visual media with chat inputs (i.e., [sends picture of fridge] “What can I cook with this”, [sends interactive platform post of an image of my face] “make me look like a vampire”). In some such examples, the user interface includes an in-chat camera with an always-scanning feature.

### Machine-Learning Pipeline

FIG. 7 is a flowchart depicting a machine-learning pipeline 700, according to some examples. The machine-learning pipeline 700 may be used to generate a trained machine-learning program 702, such as creative generation component 356 (of FIG. 3B), LLM 338 (of FIG. 3B), and intent processing component 348 (of FIG. 3B) to perform operations associated with performing searches and generating query responses.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

### Training Phases 704

Generating a trained machine-learning program 702 may include multiple phases that form part of the machine-learning pipeline 700, including for example the following phases illustrated in FIG. 6:
Data collection and preprocessing 602: This phase may include acquiring and cleaning data to ensure that it is suitable for use in the machine learning model. This phase may also include removing duplicates, handling missing values, and converting data into a suitable format.
Feature engineering 604: This phase may include selecting and transforming the training data 706 to create features that are useful for predicting the target variable. Feature engineering may include (1) receiving features 708 (e.g., as structured or labeled data in supervised learning) and/or (2) identifying features 708 (e.g., unstructured or unlabeled data for unsupervised learning) in training data 706.
Model selection and training 606: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 608: This phase may include evaluating the performance of a trained model (e.g., the trained machine-learning program 702) on a separate testing dataset. This phase can help determine if the model is overfitting or underfitting and determine whether the model is suitable for deployment.
Prediction 610: This phase involves using a trained model (e.g., trained machine-learning program 702) to generate predictions on new, unseen data.
Validation, refinement or retraining 612: This phase may include updating a model based on feedback generated from the prediction phase, such as new data or user feedback.
Deployment 614: This phase may include integrating the trained model (e.g., the trained machine-learning program 702) into a more extensive system or application, such as a web service, mobile app, or IoT device. This phase can involve setting up APIs, building a user interface, and ensuring that the model is scalable and can handle large volumes of data.

FIG. 7 illustrates further details of two example phases, namely a training phase 704 (e.g., part of the model selection and trainings 606) and a prediction phase 710 (part of prediction 610). Prior to the training phase 704, feature engineering 604 is used to identify features 708. This may include identifying informative, discriminating, and independent features for effectively operating the trained machine-learning program 702 in pattern recognition, classification, and regression. In some examples, the training data 706 includes labeled data, known for pre-identified features 708 and one or more outcomes. Each of the features 708 may be a variable or attribute, such as an individual measurable property of a process, article, system, or phenomenon represented by a data set (e.g., the training data 706). Features 708 may also be of different types, such as numeric features, strings, and graphs, and may include one or more of content 712, concepts 714, attributes 716, historical data 718 , and/or user data 720, merely for example.

In training phase 704, the machine-learning pipeline 700 uses the training data 706 to find correlations among the features 708 that affect a predicted outcome or prediction/inference data 722.

With the training data 706 and the identified features 708, the trained machine-learning program 702 is trained during the training phase 704 during machine-learning program training 724. The machine-learning program training 724 appraises values of the features 708 as they correlate to the training data 706. The result of the training is the trained machine-learning program 702 (e.g., a trained or learned model).

Further, the training phase 704 may involve machine learning, in which the training data 706 is structured (e.g., labeled during preprocessing operations). The trained machine-learning program 702 implements a neural network 726 capable of performing, for example, classification and clustering operations. In other examples, the training phase 704 may involve deep learning, in which the training data 706 is unstructured, and the trained machine-learning program 702 implements a deep neural network 726 that can perform both feature extraction and classification/clustering operations.

In some examples, a neural network 726 may be generated during the training phase 704, and implemented within the trained machine-learning program 702. The neural network 726 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 726 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 726 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 704, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 710, the trained machine-learning program 702 uses the features 708 for analyzing query data 728 to generate inferences, outcomes, or predictions, as examples of a prediction/inference data 722. For example, during prediction phase 710, the trained machine-learning program 702 generates an output. Query data 728 is provided as an input to the trained machine-learning program 702, and the trained machine-learning program 702 generates the prediction/inference data 722 as output, responsive to receipt of the query data 728.

In some examples, the trained machine-learning program 702 may be a generative AI model. Generative AI is a term that may refer to any type of artificial intelligence that can create new content from training data 706. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 728 may include text, audio, image, video, numeric, or media content prompts and the output inference/prediction data 722 includes text, images, video, audio, code, or synthetic data.

### Data Architecture

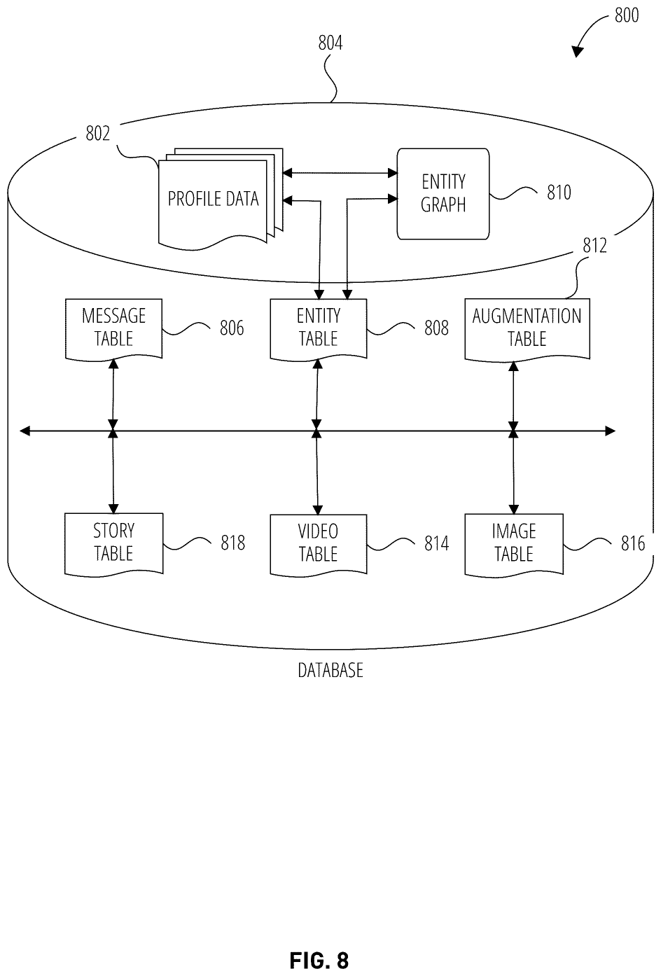

FIG. 8 is a schematic diagram illustrating data structures 800, which may be stored in the database 804 of the interaction server system 110, according to certain examples. While the content of the database 804 is shown to comprise multiple tables, it will be appreciated that the data could be stored in other types of data structures (e.g., as an object-oriented database).

The database 804 includes message data stored within a message table 806. This message data includes, for any particular message, at least message sender data, message recipient (or receiver) data, and a payload. Further details regarding information that may be included in a message, and included within the message data stored in the message table 806, are described below with reference to FIG. 8.

An entity table 808 stores entity data, and is linked (e.g., referentially) to an entity graph 810 and profile data 802. Entities for which records are maintained within the entity table 808 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 810 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 808. Such privacy settings may be applied to all types of relationships within the context of the interaction system 100, or may selectively be applied to only certain types of relationships.

The profile data 802 stores multiple types of profile data about a particular entity. The profile data 802 may be selectively used and presented to other users of the interaction system 100 based on privacy settings specified by a particular entity. Where the entity is an individual, the profile data 802 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 802 for the group may similarly include one or more avatar representations associated with the group, in addition to the group name, members, and various settings (e.g., notifications) for the relevant group.

The database 804 also stores augmentation data, such as overlays or filters, in an augmentation table 812. The augmentation data is associated with and applied to videos (for which data is stored in a video table 814) and images (for which data is stored in an image table 816).

Filters, in some examples, are overlays that are displayed as overlaid on an image or video during presentation to a message receiver. Filters may be of various types, including user-selected filters from a set of filters presented to a message sender by the interaction client 104 when the message sender is composing a message. Other types of filters include geolocation filters (also known as geo-filters), which may be presented to a message sender based on geographic location. For example, geolocation filters specific to a neighborhood or special location may be presented within a user interface by the interaction client 104, based on geolocation information determined by a Global Positioning System (GPS) unit of the client system 102.

Another type of filter is a data filter, which may be selectively presented to a message sender by the interaction client 104 based on other inputs or information gathered by the client system 102 during the message creation process. Examples of data filters include current temperature at a specific location, a current speed at which a message sender is traveling, battery life for a client system 102, or the current time.

Other augmentation data that may be stored within the image table 816 includes augmented reality content items (e.g., corresponding to applying Lenses or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the client system 102 and then displayed on a screen of the client system 102 with the modifications. This also includes modifications to stored content, such as video clips in a collection or group that may be modified. For example, in a client system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a client system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the client system 102) and perform complex image manipulations locally on the client system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client system 102.

In some examples, a computer animation model to transform image data can be used by a system where a user may capture an image or video stream of the user (e.g., a selfie) using the client system 102 having a neural network operating as part of an interaction client 104 operating on the client system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 818 stores data regarding collections of messages and associated image, video, or audio data, which are compiled into a collection (e.g., a story or a gallery). The creation of a particular collection may be initiated by a particular user (e.g., each user for which a record is maintained in the entity table 808). A user may create a “personal story” in the form of a collection of content that has been created and sent/broadcast by that user. To this end, the user interface of the interaction client 104 may include an icon that is user-selectable to enable a message sender to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose client system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 814 stores video data that, in some examples, is associated with messages for which records are maintained within the message table 806. Similarly, the image table 816 stores image data associated with messages for which message data is stored in the entity table 808. The entity table 808 may associate various augmentations from the augmentation table 812 with various images and videos stored in the image table 816 and the video table 814.

The databases 804 also include social network information collected by an interaction system of an interactive platform. The social network information may include without limitation relationship and communication data for users of the interactive platform. The social network information can be used to group two or more users and offer additional functionality of the interaction system 100. Examples of relationships include, but are not limited to, best friends relationships where two or more users are determined to be mutual best friends based on a frequency of their interactions, users who have common interests in current events, users who share an affiliation through social clubs or philanthropic organizations, and the like. Examples of communications include without limitation chats, private and public messages, exchanges of media such as images, videos, audio recordings, and the like.

### Data Communications Architecture

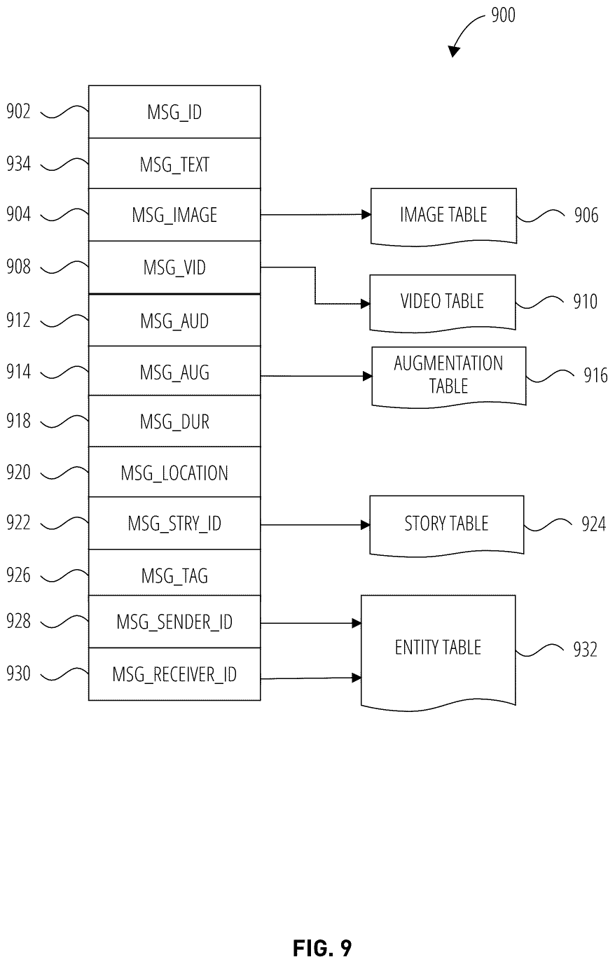

FIG. 9 is a schematic diagram illustrating a structure of a message 900, according to some examples, generated by an interaction client 104 for communication to a further interaction client 104 via the interaction servers 124. The content of a particular message 900 is used to populate the message table 806 stored within the database 804, accessible by the interaction servers 124. Similarly, the content of a message 900 is stored in memory as “in-transit” or “in-flight” data of the client system 102 or the interaction servers 124. A message 900 is shown to include the following example components:
Message identifier 902: a unique identifier that identifies the message 900.
Message text payload 934: text, to be generated by a user via a user interface of the client system 102, and that is included in the message 900.
Message image payload 904: image data, captured by a camera component of a client system 102 or retrieved from a memory component of a client system 102, and that is included in the message 900. Image data for a sent or received message 900 may be stored in the image table 906.
Message video payload 908: video data, captured by a camera component or retrieved from a memory component of the client system 102, and that is included in the message 900. Video data for a sent or received message 900 may be stored in the video table 910.
Message audio payload 912: audio data, captured by a microphone or retrieved from a memory component of the client system 102, and that is included in the message 900.
Message augmentation data 914: augmentation data (e.g., filters, stickers, or other annotations or enhancements) that represents augmentations to be applied to message image payload 904, message video payload 908, or message audio payload 912 of the message 900. Augmentation data for a sent or received message 900 may be stored in the augmentation table 916.
Message duration parameter 918: parameter value indicating, in seconds, the amount of time for which content of the message (e.g., the message image payload 904, message video payload 908, message audio payload 912) is to be presented or made accessible to a user via the interaction client 104.
Message geolocation parameter 920: geolocation data (e.g., latitudinal and longitudinal coordinates) associated with the content payload of the message. Multiple message geolocation parameter 920 values may be included in the payload, each of these parameter values being associated with respect to content items included in the content (e.g., a specific image within the message image payload 904, or a specific video in the message video payload 908).
Message story identifier 922: identifier values identifying one or more content collections (e.g., “stories” identified in the story table 924) with which a particular content item in the message image payload 904 of the message 900 is associated. For example, multiple images within the message image payload 904 may each be associated with multiple content collections using identifier values.
Message tag 926: each message 900 may be tagged with multiple tags, each of which is indicative of the subject matter of content included in the message payload. For example, where a particular image included in the message image payload 904 depicts an animal (e.g., a lion), a tag value may be included within the message tag 926 that is indicative of the relevant animal. Tag values may be generated manually, based on user input, or may be automatically generated using, for example, image recognition.
Message sender identifier 928: an identifier (e.g., a messaging system identifier, email address, or device identifier) indicative of a user of the client system 102 on which the message 900 was generated and from which the message 900 was sent.
Message receiver identifier 930: an identifier (e.g., a messaging system identifier, email address, or device identifier) indicative of a user of the client system 102 to which the message 900 is addressed.

The contents (e.g., values) of the various components of message 900 may be pointers to locations in tables within which content data values are stored. For example, an image value in the message image payload 904 may be a pointer to (or address of) a location within an image table 906. Similarly, values within the message video payload 908 may point to data stored within a video table 910, values stored within the message augmentation data 914 may point to data stored in an augmentation table 916, values stored within the message story identifier 922 may point to data stored in a story table 924, and values stored within the message sender identifier 928 and the message receiver identifier 930 may point to user records stored within an entity table 932.

### Time-Based Access Limitation Architecture

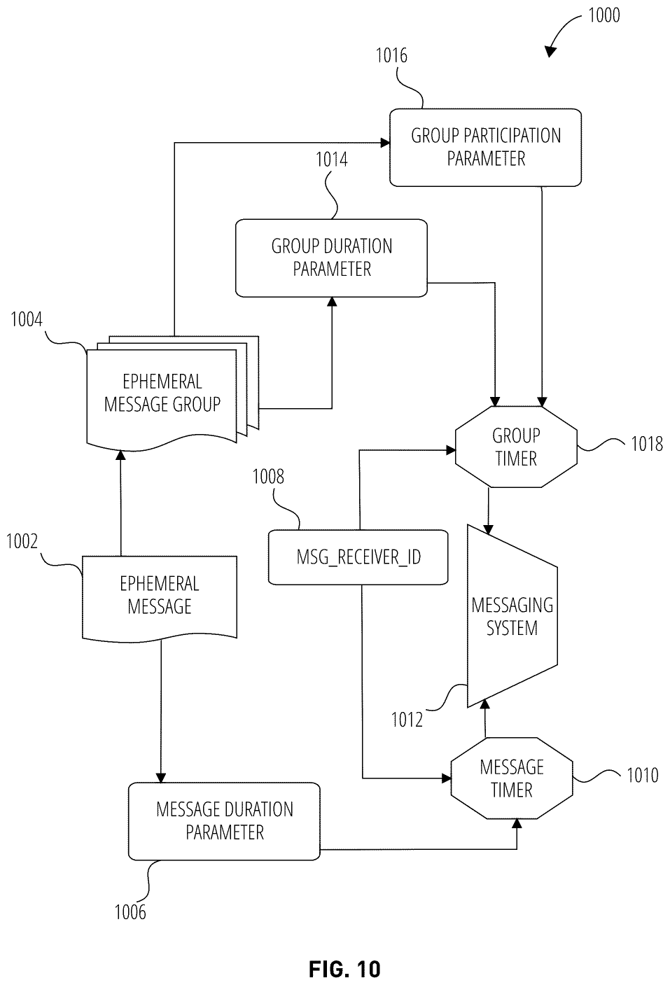

FIG. 10 is a schematic diagram illustrating an access-limiting process 1000, in terms of which access to content (e.g., an ephemeral message 1002 and associated multimedia payload of data) or a content collection (e.g., an ephemeral message group 1004) may be time-limited (e.g., made ephemeral).

An ephemeral message 1002 is shown to be associated with a message duration parameter 1006, the value of which determines the amount of time that the ephemeral message 1002 will be displayed to a receiving user of the ephemeral message 1002 by the interaction client 104. In some examples, an ephemeral message 1002 is viewable by a receiving user for up to a maximum of 10 seconds, depending on the amount of time that the message sender specifies using the message duration parameter 1006.

The message duration parameter 1006 and the message receiver identifier 1008 are shown to be inputs to a message timer 1010, which is responsible for determining the amount of time that the ephemeral message 1002 is shown to a particular receiving user identified by the message receiver identifier 1008. In particular, the ephemeral message 1002 will be shown to the relevant receiving user for a time period determined by the value of the message duration parameter 1006. The message timer 1010 is shown to provide output to a more generalized messaging system 1012, which is responsible for the overall timing of display of content (e.g., an ephemeral message 1002) to a receiving user.

The ephemeral message 1002 is shown in FIG. 10 to be included within an ephemeral message group 1004 (e.g., a collection of messages in a personal story, or an event story). The ephemeral message group 1004 has an associated group duration parameter 1014, a value of which determines a time duration for which the ephemeral message group 1004 is presented and accessible to users of the interaction system 100. The group duration parameter 1014, for example, may be the duration of a music concert, where the ephemeral message group 1004 is a collection of content pertaining to that concert. Alternatively, a user (either the owning user or a curator user) may specify the value for the group duration parameter 1014 when performing the setup and creation of the ephemeral message group 1004.

Additionally, each ephemeral message 1002 within the ephemeral message group 1004 has an associated group participation parameter 1016, a value of which determines the duration of time for which the ephemeral message 1002 will be accessible within the context of the ephemeral message group 1004. Accordingly, a particular ephemeral message group 1004 may “expire” and become inaccessible within the context of the ephemeral message group 1004 prior to the ephemeral message group 1004 itself expiring in terms of the group duration parameter 1014. The group duration parameter 1014, group participation parameter 1016, and message receiver identifier 1008 each provide input to a group timer 1018, which operationally determines, firstly, whether a particular ephemeral message 1002 of the ephemeral message group 1004 will be displayed to a particular receiving user and, if so, for how long. Note that the ephemeral message group 1004 is also aware of the identity of the particular receiving user as a result of the message receiver identifier 1008.

Accordingly, the group timer 1018 operationally controls the overall lifespan of an associated ephemeral message group 1004 as well as an individual ephemeral message 1002 included in the ephemeral message group 1004. In some examples, each and every ephemeral message 1002 within the ephemeral message group 1004 remains viewable and accessible for a time period specified by the group duration parameter 1014. In a further example, a certain ephemeral message 1002 may expire within the context of ephemeral message group 1004 based on a group participation parameter 1016. Note that a message duration parameter 1006 may still determine the duration of time for which a particular ephemeral message 1002 is displayed to a receiving user, even within the context of the ephemeral message group 1004. Accordingly, the message duration parameter 1006 determines the duration of time that a particular ephemeral message 1002 is displayed to a receiving user regardless of whether the receiving user is viewing that ephemeral message 1002 inside or outside the context of an ephemeral message group 1004.

The messaging system 1012 may furthermore operationally remove a particular ephemeral message 1002 from the ephemeral message group 1004 based on a determination that it has exceeded an associated group participation parameter 1016. For example, when a message sender has established a group participation parameter 1016 of 24 hours from posting, the messaging system 1012 will remove the relevant ephemeral message 1002 from the ephemeral message group 1004 after the specified 24 hours. The messaging system 1012 also operates to remove an ephemeral message group 1004 when either the group participation parameter 1016 for each and every ephemeral message 1002 within the ephemeral message group 1004 has expired, or when the ephemeral message group 1004 itself has expired in terms of the group duration parameter 1014.

In certain use cases, a creator of a particular ephemeral message group 1004 may specify an indefinite group duration parameter 1014. In this case, the expiration of the group participation parameter 1016 for the last remaining ephemeral message 1002 within the ephemeral message group 1004 will determine when the ephemeral message group 1004 itself expires. In this case, a new ephemeral message 1002, added to the ephemeral message group 1004, with a new group participation parameter 1016, effectively extends the life of an ephemeral message group 1004 to equal the value of the group participation parameter 1016.

Responsive to the messaging system 1012 determining that an ephemeral message group 1004 has expired (e.g., is no longer accessible), the messaging system 1012 communicates with the interaction system 100 (and, for example, specifically the interaction client 104) to cause an indicium (e.g., an icon) associated with the relevant ephemeral message group 1004 to no longer be displayed within a user interface of the interaction client 104. Similarly, when the messaging system 1012 determines that the message duration parameter 1006 for a particular ephemeral message 1002 has expired, the messaging system 1012 causes the interaction client 104 to no longer display an indicium (e.g., an icon or textual identification) associated with the ephemeral message 1002.

### Machine Architecture

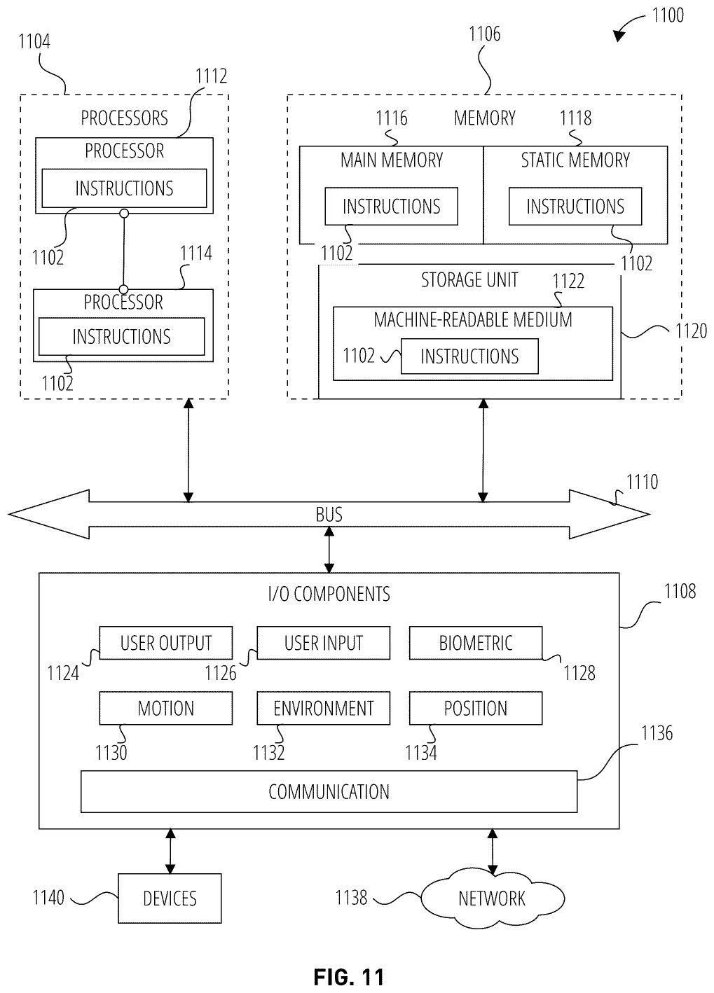

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the client system 102 or any one of multiple server devices forming part of the interaction server system 110. In some examples, the machine 1100 may also comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1130 include acceleration sensor components (e.g., accelerometer), gravitation sensor components, rotation sensor components (e.g., gyroscope). The biometric components 1128 may include a brain-machine interface (BMI) system that allows communication between the brain and an external device or machine. This is achieved by recording brain activity, translating it into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which involve surgically implanting electrodes directly into the brain.
Optogenetics BMIs, which use light to control the activity of specific nerve cells in the brain.
Functional magnetic resonance imaging (fMRI)-based BMIs, which use magnetic fields to measure blood flow in the brain, which can be used to infer brain activity.

Any biometric data collected by the biometric components 1128 are captured and cached with only user approval and deleted on user request. Further, such biometric data may be used for very limited purposes, such as identification verification. To ensure limited and authorized use of biometric information and other Personally Identifiable Information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The environmental components 1132 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client system 102 may have a camera system comprising, for example, front cameras on a front surface of the client system 102 and rear cameras on a rear surface of the client system 102. The front cameras may for example, be used to capture still images and video of a user of the client system 102 (e.g., “selfies”), which may then be augmented with augmentation data (e.g., filters) described above. The rear cameras may for example, be used to capture still images and videos in a more traditional camera mode, with these images similarly being augmented with augmentation data. In addition to front and rear cameras, the client system 102 may also include a 360° camera for capturing 360° photographs and videos.

Further, the camera system of the client system 102 may include dual rear cameras (e.g., a primary camera as well as a depth-sensing camera), or even triple, quad or penta rear camera configurations on the front and rear sides of the client system 102. These multiple cameras systems may include a wide camera, an ultra-wide camera, a telephoto camera, a macro camera, and a depth sensor, for example.

The position components 1134 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1108 further include communication components 1136 operable to couple the machine 1100 to a network 1138 or devices 1140 via respective coupling or connections. For example, the communication components 1136 may include a network interface component or another suitable device to interface with the network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

### Software Architecture

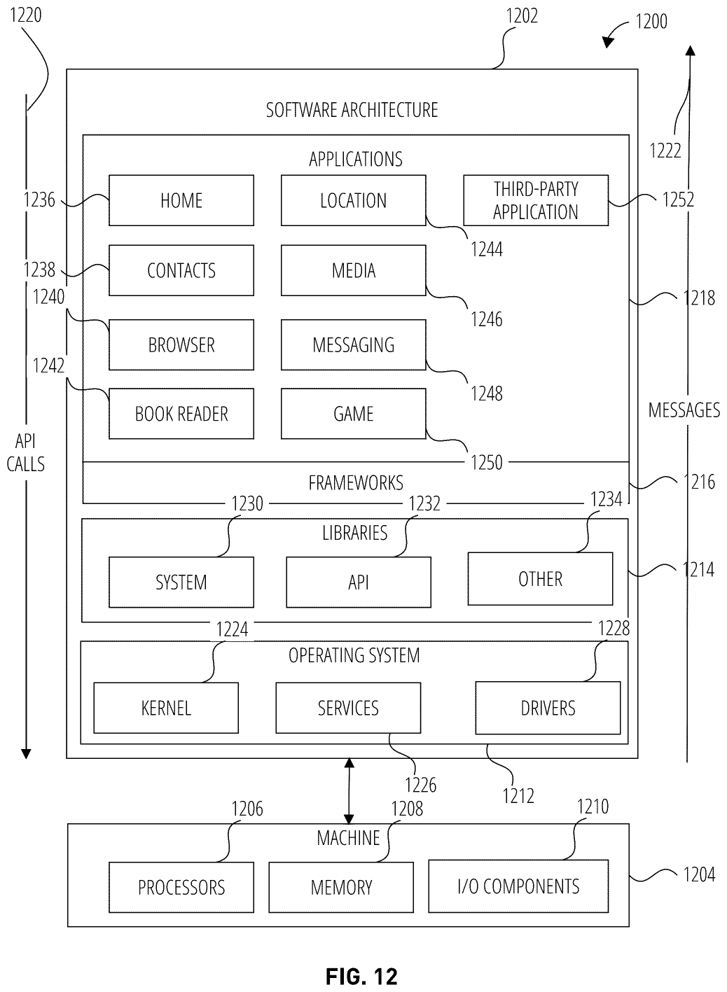

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematic functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

Additional examples include:

Example 1 is a method of one or more processors, the method comprising: receiving, by the one or more processors, from a client system, a prompt of a user during a first interactive session; generating, by the one or more processors, a response using the prompt and a large language model; communicating, by the one or more processors, during the first interactive session, the response to the client system for display to the user; determining, by the one or more processors, a user intent based on the user prompt; determining, by the one or more processors, advertising content based on the user intent; and communicating, by the one or more processors, during a second interactive session, the advertising content to the client system for display to the user.

In Example 2, the subject matter of Example 1 includes, wherein the first interactive session is a chat session with a chatbot and the second interactive session is not a chat session with a chatbot.

In Example 3, the subject matter of any of Examples 1-2 includes, wherein generating a response further comprises: generating a raw response based on the user prompt; generating an adjusted input prompt based on the raw response; and generating the response based on the adjusted input prompt.

In Example 4, the subject matter of any of Examples 1-3 includes, wherein generating the adjusted input further comprises: generating a set of potential responses; and selecting the response from the set of potential responses.

In Example 5, the subject matter of any of Examples 1-4 includes, wherein determining the user intent is further based on the potential responses.

In Example 6, the subject matter of any of Examples 1-5 includes, wherein determining the user intent is further based on a user profile.

In Example 7, the subject matter of any of Examples 1-6 includes, wherein the user profile includes social network data of a social network of the user.

Example 8 is at least one machine-readable medium including instructions that, when executed by processing circuitry, cause the processing circuitry to perform operations to implement any of Examples 1-7.

Example 9 is an apparatus comprising means to implement any of Examples 1-7.

Example 10 is a system to implement any of Examples 1-7.

### Conclusion

Changes and modifications may be made to the disclosed examples without departing from the scope of the present disclosure. These and other changes or modifications are intended to be included within the scope of the present disclosure.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine-storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method of one or more processors, the method comprising:
receiving, by the one or more processors, from a client system, a prompt of a user during a first interactive session;
generating, by the one or more processors, a response using the prompt and a large language model;
communicating, by the one or more processors, during the first interactive session, the response to the client system for display to the user;
determining, by the one or more processors, a user intent based on the user prompt;
determining, by the one or more processors, advertising content based on the user intent; and
communicating, by the one or more processors, during a second interactive session, the advertising content to the client system for display to the user.

2. The method of claim 1, wherein the first interactive session is a chat session with a chatbot and the second interactive session is not a chat session with a chatbot.

3. The method of claim 1, wherein generating a response further comprises:
generating a raw response based on the user prompt;
generating an adjusted input prompt based on the raw response; and
generating the response based on the adjusted input prompt.

4. The method of claim 3, wherein generating the adjusted input further comprises:
generating a set of potential responses; and
selecting the response from the set of potential responses.

5. The method of claim 4, wherein determining the user intent is further based on the potential responses.

6. The method of claim 1, wherein determining the user intent is further based on a user profile.

7. The method of claim 6, wherein the user profile includes social network data of a social network of the user.

8. A machine comprising:
one or more processors; and
a memory storing instructions that, when executed by the one or more processors, cause the machine to perform operations comprising:
receiving from a client system, a prompt of a user during a first interactive session;
generating a response using the prompt and a large language model;
communicating during the first interactive session, the response to the client system for display to the user;
determining a user intent based on the user prompt;
determining advertising content based on the user intent; and
communicating, during a second interactive session, the advertising content to the client system for display to the user.

9. The machine of claim 8, wherein the first interactive session is a chat session with a chatbot and the second interactive session is not a chat session with a chatbot.

10. The machine of claim 8, wherein generating a response further comprises:
generating a raw response based on the user prompt;
generating an adjusted input prompt based on the raw response; and
generating the response based on the adjusted input prompt.

11. The machine of claim 10, wherein generating the adjusted input further comprises:
generating a set of potential responses; and
selecting the response from the set of potential responses.

12. The machine of claim 11, wherein determining the user intent is further based on the potential responses.

13. The machine of claim 8, wherein determining the user intent is further based on a user profile.

14. The machine of claim 13, wherein the user profile includes social network data of a social network of the user.

15. A machine-storage medium storing instructions that, when executed by a machine, cause the machine to perform operations comprising:
receiving from a client system, a prompt of a user during a first interactive session;
generating a response using the prompt and a large language model;
communicating during the first interactive session, the response to the client system for display to the user;
determining a user intent based on the user prompt;
determining advertising content based on the user intent; and
communicating, during a second interactive session, the advertising content to the client system for display to the user.

16. The computer-readable medium of claim 15, wherein the first interactive session is a chat session with a chatbot and the second interactive session is not a chat session with a chatbot.

17. The computer-readable medium of claim 15, wherein generating a response further comprises:
generating a raw response based on the user prompt;
generating an adjusted input prompt based on the raw response; and
generating the response based on the adjusted input prompt.

18. The computer-readable medium of claim 17, wherein generating the adjusted input further comprises:
generating a set of potential responses; and
selecting the response from the set of potential responses.

19. The computer-readable medium of claim 18, wherein determining the user intent is further based on the potential responses.

20. The computer-readable medium of claim 15, wherein determining the user intent is further based on a user profile.
